SEQUENCE LISTING (311 sequences)

SEQ ID NO: 1 - protein, 12 aa, Artificial
  Synthetic peptide
MYQDTPPPRKNV

SEQ ID NO: 2 - protein, 12 aa, Artificial
  Synthetic peptide
MYQPGPQGLPQS

SEQ ID NO: 3 - protein, 12 aa, Artificial
  Synthetic peptide
MYQPPSTTRMYP

SEQ ID NO: 4 - protein, 12 aa, Artificial
  Synthetic peptide
MYQDAGPTEWSY

SEQ ID NO: 5 - protein, 12 aa, Artificial
  Synthetic peptide
MWQPAPPSVRGA

SEQ ID NO: 6 - protein, 12 aa, Artificial
  Synthetic peptide
MFQSAGYPSSFR

SEQ ID NO: 7 - protein, 12 aa, Artificial
  Synthetic peptide
MFQEHTPAFGGL

SEQ ID NO: 8 - protein, 12 aa, Artificial
  Synthetic peptide
MFQEPLPPFKAS

SEQ ID NO: 9 - protein, 12 aa, Artificial
  Synthetic peptide
MFQPTHWGTRLS

SEQ ID NO: 10 - protein, 12 aa, Artificial
  Synthetic peptide
MQQPAGWKYLGQ

SEQ ID NO: 11 - protein, 12 aa, Artificial
  Synthetic peptide
MVQELPFVLRSK

SEQ ID NO: 12 - protein, 12 aa, Artificial
  Synthetic peptide
TFQPRSWPNIDL

SEQ ID NO: 13 - protein, 12 aa, Artificial
  Synthetic peptide
TFQYLDPPPFTP

SEQ ID NO: 14 - protein, 12 aa, Artificial
  Synthetic peptide
TYQHNNPDAFRL

SEQ ID NO: 15 - protein, 12 aa, Artificial
  Synthetic peptide
MFQSNTYPIWNV

SEQ ID NO: 16 - protein, 12 aa, Artificial
  Synthetic peptide
FQPNPPPSFAAP

SEQ ID NO: 17 - protein, 12 aa, Artificial
  Synthetic peptide
MYQGRNDPHLLP

SEQ ID NO: 18 - protein, 12 aa, Artificial
  Synthetic peptide
MYQPRDWRSAPP

SEQ ID NO: 19 - protein, 12 aa, Artificial
  Synthetic peptide
MFNADPTIPAQP

SEQ ID NO: 20 - protein, 7 aa, Artificial
  Synthetic peptide
HGTNNTD

SEQ ID NO: 21 - protein, 7 aa, Artificial
  Synthetic peptide
QLDNLTT

SEQ ID NO: 22 - protein, 7 aa, Artificial
  Synthetic peptide
HYYHNTD

SEQ ID NO: 23 - protein, 7 aa, Artificial
  Synthetic peptide
HALPLHA

SEQ ID NO: 24 - protein, 7 aa, Artificial
  Synthetic peptide
MFQEHPI

SEQ ID NO: 25 - protein, 7 aa, Artificial
  Synthetic peptide
MWQPSTF

SEQ ID NO: 26 - protein, 7 aa, Artificial
  Synthetic peptide
MFQPAVQ

SEQ ID NO: 27 - protein, 7 aa, Artificial
  Synthetic peptide
MYQPLAL

SEQ ID NO: 28 - protein, 7 aa, Artificial
  Synthetic peptide
MFQPDFL

SEQ ID NO: 29 - protein, 7 aa, Artificial
  Synthetic peptide
MFQELVI

SEQ ID NO: 30 - protein, 7 aa, Artificial
  Synthetic peptide
MFQANTV

SEQ ID NO: 31 - protein, 7 aa, Artificial
  Synthetic peptide
MFQPLHR

SEQ ID NO: 32 - protein, 7 aa, Artificial
  Synthetic peptide
MFQPTDH

SEQ ID NO: 33 - protein, 7 aa, Artificial
  Synthetic peptide
MFQPLPS

SEQ ID NO: 34 - protein, 7 aa, Artificial
  Synthetic peptide
MFQPQYH

SEQ ID NO: 35 - protein, 7 aa, Artificial
  Synthetic peptide
MFQPPLK

SEQ ID NO: 36 - protein, 7 aa, Artificial
  Synthetic peptide
MYQPPGS

SEQ ID NO: 37 - protein, 7 aa, Artificial
  Synthetic peptide
MYQPRTL

SEQ ID NO: 38 - protein, 7 aa, Artificial
  Synthetic peptide
MWQPDAR

SEQ ID NO: 39 - protein, 7 aa, Artificial
  Synthetic peptide
MYQDLPY

SEQ ID NO: 40 - protein, 12 aa, Artificial
  Synthetic peptide
MWQPQPMPGMVG

SEQ ID NO: 41 - protein, 12 aa, Artificial
  Synthetic peptide
MYQPRNWSDASG

SEQ ID NO: 42 - protein, 12 aa, Artificial
  Synthetic peptide
TYQPKSPSNFAN

SEQ ID NO: 43 - protein, 12 aa, Artificial
  Synthetic peptide
MFQPNNPPGIHA

SEQ ID NO: 44 - protein, 7 aa, Artificial
  Synthetic peptide
MFQPYHP

SEQ ID NO: 45 - protein, 7 aa, Artificial
  Synthetic peptide
MYNPPWG

SEQ ID NO: 46 - protein, 7 aa, Artificial
  Synthetic peptide
TYQPLTW

SEQ ID NO: 47 - protein, 12 aa, Artificial
  Synthetic peptide
VSHTNNTDLRPP

SEQ ID NO: 48 - protein, 12 aa, Artificial
  Synthetic peptide
DHPPTLNRPPNV

SEQ ID NO: 49 - protein, 7 aa, Artificial
  Synthetic peptide
HGVSNTD

SEQ ID NO: 50 - protein, 7 aa, Artificial
  Synthetic peptide
MWQPRTM

SEQ ID NO: 51 - protein, 7 aa, Artificial
  Synthetic peptide
HYHSNTD

SEQ ID NO: 52 - protein, 7 aa, Artificial
  Synthetic peptide
HYASNTD

SEQ ID NO: 53 - protein, 7 aa, Artificial
  Synthetic peptide
MYQPMTA

SEQ ID NO: 54 - protein, 12 aa, Artificial
  Synthetic peptide
MYQPNSTTQLYN

SEQ ID NO: 55 - protein, 12 aa, Artificial
  Synthetic peptide
NFQPNDPPARPS

SEQ ID NO: 56 - protein, 12 aa, Artificial
  Synthetic peptide
TYQHMPPPHSPF

SEQ ID NO: 57 - protein, 12 aa, Artificial
  Synthetic peptide
MYQESAPPRQVF

SEQ ID NO: 58 - protein, 12 aa, Artificial
  Synthetic peptide
MWQPNSPSVPPP

SEQ ID NO: 59 - protein, 7 aa, Artificial
  Synthetic peptide
IFNDPWM

SEQ ID NO: 60 - protein, 7 aa, Artificial
  Synthetic peptide
MFQPLPA

SEQ ID NO: 61 - protein, 7 aa, Artificial
  Synthetic peptide
MYQPTHW

SEQ ID NO: 62 - protein, 12 aa, Artificial
  Synthetic peptide
MFQPTLVAPLQA

SEQ ID NO: 63 - protein, 12 aa, Artificial
  Synthetic peptide
MFQSSPPPLGHA

SEQ ID NO: 64 - protein, 12 aa, Artificial
  Synthetic peptide
TFQPRLFSSWVH

SEQ ID NO: 65 - protein, 12 aa, Artificial
  Synthetic peptide
MFQSRGPNQLFP

SEQ ID NO: 66 - protein, 12 aa, Artificial
  Synthetic peptide
MFQPANPSQSTA

SEQ ID NO: 67 - protein, 7 aa, Artificial
  Synthetic peptide
MWQPQWT

SEQ ID NO: 68 - protein, 7 aa, Artificial
  Synthetic peptide
MFQPPRN

SEQ ID NO: 69 - protein, 7 aa, Artificial
  Synthetic peptide
MFQPRFP

SEQ ID NO: 70 - protein, 7 aa, Artificial
  Synthetic peptide
MFQPVEL

SEQ ID NO: 71 - protein, 7 aa, Artificial
  Synthetic peptide
MYQPNLM

SEQ ID NO: 72 - protein, 12 aa, Artificial
  Synthetic peptide
MYQPDPPPTKNP

SEQ ID NO: 73 - protein, 12 aa, Artificial
  Synthetic peptide
MYQPDPPPTKNV

SEQ ID NO: 74 - protein, 12 aa, Artificial
  Synthetic peptide
MYQPDPPTTKNP

SEQ ID NO: 75 - protein, 12 aa, Artificial
  Synthetic peptide
MYQPDPPTTKNV

SEQ ID NO: 76 - protein, 12 aa, Artificial
  Synthetic peptide
MYQPDNPPTKNP

SEQ ID NO: 77 - protein, 12 aa, Artificial
  Synthetic peptide
MYQPDNPPTKNV

SEQ ID NO: 78 - protein, 12 aa, Artificial
  Synthetic peptide
MYQPDNPTTKNP

SEQ ID NO: 79 - protein, 12 aa, Artificial
  Synthetic peptide
MYQPDNPTTKNV

SEQ ID NO: 80 - protein, 12 aa, Artificial
  Synthetic peptide
MFQPDPPPTKNP

SEQ ID NO: 81 - protein, 12 aa, Artificial
  Synthetic peptide
MFQPDPPPTKNV

SEQ ID NO: 82 - protein, 12 aa, Artificial
  Synthetic peptide
MFQPDPPTTKNP

SEQ ID NO: 83 - protein, 12 aa, Artificial
  Synthetic peptide
MFQPDPPTTKNV

SEQ ID NO: 84 - protein, 12 aa, Artificial
  Synthetic peptide
MFQPDNPPTKNP

SEQ ID NO: 85 - protein, 12 aa, Artificial
  Synthetic peptide
MFQPDNPPTKNV

SEQ ID NO: 86 - protein, 12 aa, Artificial
  Synthetic peptide
MFQPDNPTTKNP

SEQ ID NO: 87 - protein, 12 aa, Artificial
  Synthetic peptide
MFQPDNPTTKNV

SEQ ID NO: 88 - protein, 12 aa, Artificial
  Synthetic peptide
SPPTPPRFSDDW

SEQ ID NO: 89 - protein, 12 aa, Artificial
  Synthetic peptide
LPTLHTAHPPVQ

SEQ ID NO: 90 - protein, 12 aa, Artificial
  Synthetic peptide
GTQTRSSYVLTS

SEQ ID NO: 91 - protein, 12 aa, Artificial
  Synthetic peptide
NPHPMWNPTSYL

SEQ ID NO: 92 - protein, 12 aa, Artificial
  Synthetic peptide
AYRAVTLNQPLT

SEQ ID NO: 93 - protein, 12 aa, Artificial
  Synthetic peptide
QYLPDHRSSQPN

SEQ ID NO: 94 - protein, 12 aa, Artificial
  Synthetic peptide
LPHRTDYLYTPE

SEQ ID NO: 95 - protein, 12 aa, Artificial
  Synthetic peptide
HPAVQPPLIYMF

SEQ ID NO: 96 - protein, 12 aa, Artificial
  Synthetic peptide
VPTYEIIARGIR

SEQ ID NO: 97 - protein, 12 aa, Artificial
  Synthetic peptide
SPSDMFISTQRL

SEQ ID NO: 98 - protein, 12 aa, Artificial
  Synthetic peptide
LLTQTTAYAPMS

SEQ ID NO: 99 - protein, 12 aa, Artificial
  Synthetic peptide
MMNSDPKSFLSL

SEQ ID NO: 100 - protein, 12 aa, Artificial
  Synthetic peptide
MRNDVPWIPWPV

SEQ ID NO: 101 - protein, 12 aa, Artificial
  Synthetic peptide
TLPYLKMHRNLL

SEQ ID NO: 102 - protein, 7 aa, Artificial
  Synthetic peptide
QSYSPRF

SEQ ID NO: 103 - protein, 7 aa, Artificial
  Synthetic peptide
LKQRTLM

SEQ ID NO: 104 - protein, 7 aa, Artificial
  Synthetic peptide
QSYPQAL

SEQ ID NO: 105 - protein, 7 aa, Artificial
  Synthetic peptide
QSYSPKY

SEQ ID NO: 106 - protein, 7 aa, Artificial
  Synthetic peptide
AMYQPTH

SEQ ID NO: 107 - protein, 7 aa, Artificial
  Synthetic peptide
HWYHNTD

SEQ ID NO: 108 - protein, 7 aa, Artificial
  Synthetic peptide
LSYSPRY

SEQ ID NO: 109 - protein, 7 aa, Artificial
  Synthetic peptide
ESYSPRH

SEQ ID NO: 110 - protein, 7 aa, Artificial
  Synthetic peptide
QSYPSVY

SEQ ID NO: 111 - protein, 7 aa, Artificial
  Synthetic peptide
DSYSPKF

SEQ ID NO: 112 - protein, 7 aa, Artificial
  Synthetic peptide
QSYPAKF

SEQ ID NO: 113 - protein, 7 aa, Artificial
  Synthetic peptide
RSASALW

SEQ ID NO: 114 - protein, 7 aa, Artificial
  Synthetic peptide
ESYSPRL

SEQ ID NO: 115 - protein, 7 aa, Artificial
  Synthetic peptide
PIFTKLH

SEQ ID NO: 116 - protein, 7 aa, Artificial
  Synthetic peptide
QSYPYRG

SEQ ID NO: 117 - protein, 7 aa, Artificial
  Synthetic peptide
WQSYPNP

SEQ ID NO: 118 - protein, 7 aa, Artificial
  Synthetic peptide
TNLRLPA

SEQ ID NO: 119 - protein, 7 aa, Artificial
  Synthetic peptide
YQSYPPP

SEQ ID NO: 120 - protein, 7 aa, Artificial
  Synthetic peptide
YQSYPMR

SEQ ID NO: 121 - protein, 7 aa, Artificial
  Synthetic peptide
MYPDWQQ

SEQ ID NO: 122 - protein, 7 aa, Artificial
  Synthetic peptide
LERDPPV

SEQ ID NO: 123 - protein, 7 aa, Artificial
  Synthetic peptide
YQSYPNW

SEQ ID NO: 124 - protein, 7 aa, Artificial
  Synthetic peptide
LVPPDGY

SEQ ID NO: 125 - protein, 7 aa, Artificial
  Synthetic peptide
APFWQWM

SEQ ID NO: 126 - protein, 7 aa, Artificial
  Synthetic peptide
FSPPNWY

SEQ ID NO: 127 - protein, 8 aa, Artificial
  Synthetic peptide
FAPWYQQR

SEQ ID NO: 128 - protein, 7 aa, Artificial
  Synthetic peptide
QSYPNTF

SEQ ID NO: 129 - protein, 7 aa, Artificial
  Synthetic peptide
DWLFKMS

SEQ ID NO: 130 - protein, 6 aa, Artificial
  Synthetic peptide
GDWLHW

SEQ ID NO: 131 - protein, 7 aa, Artificial
  Synthetic peptide
SDGDYGA

SEQ ID NO: 132 - protein, 7 aa, Artificial
  Synthetic peptide
GPSWQST

SEQ ID NO: 133 - protein, 8 aa, Artificial
  Synthetic peptide
VPYPNQMC

SEQ ID NO: 134 - protein, 6 aa, Artificial
  Synthetic peptide
PSPGQI

SEQ ID NO: 135 - protein, 12 aa, Artificial
  Synthetic peptide
FEPPNWDSGPRP

SEQ ID NO: 136 - protein, 12 aa, Artificial
  Synthetic peptide
GIAEDDYGALSW

SEQ ID NO: 137 - protein, 12 aa, Artificial
  Synthetic peptide
YNQYQSYPPSLQ

SEQ ID NO: 138 - protein, 12 aa, Artificial
  Synthetic peptide
YQSYPSRPPVRL

SEQ ID NO: 139 - protein, 12 aa, Artificial
  Synthetic peptide
ALAPEEDEVYYV

SEQ ID NO: 140 - protein, 12 aa, Artificial
  Synthetic peptide
VLLPESDESHRA

SEQ ID NO: 141 - protein, 7 aa, Artificial
  Synthetic peptide
IPNWQSC

SEQ ID NO: 142 - protein, 15 aa, Artificial
  Synthetic peptide
SGVAFCPPWWCDGPL

SEQ ID NO: 143 - protein, 15 aa, Artificial
  Synthetic peptide
WPRHVPLFGLDGYVT

SEQ ID NO: 144 - protein, 15 aa, Artificial
  Synthetic peptide
AREYGTRFSLIGGYR

SEQ ID NO: 145 - protein, 15 aa, Artificial
  Synthetic peptide
ASRRLLPSDVRLPSS

SEQ ID NO: 146 - protein, 15 aa, Artificial
  Synthetic peptide
LWDPPPFGLSRIFFG

SEQ ID NO: 147 - protein, 15 aa, Artificial
  Synthetic peptide
DARPLAWYEEPSFWM

SEQ ID NO: 148 - protein, 15 aa, Artificial
  Synthetic peptide
SGYARPFYQSYPAAS

SEQ ID NO: 149 - protein, 12 aa, Artificial
  Synthetic peptide
VNSTKWPGMPSF

SEQ ID NO: 150 - protein, 12 aa, Artificial
  Synthetic peptide
VSPPEWYPLAAD

SEQ ID NO: 151 - protein, 12 aa, Artificial
  Synthetic peptide
TGPKLHCPPAVC

SEQ ID NO: 152 - protein, 12 aa, Artificial
  Synthetic peptide
FKNPSQSYPPEP

SEQ ID NO: 153 - protein, 12 aa, Artificial
  Synthetic peptide
FTMERDPPIARV

SEQ ID NO: 154 - protein, 7 aa, Artificial
  Synthetic peptide
GLFKIQP

SEQ ID NO: 155 - protein, 7 aa, Artificial
  Synthetic peptide
LGHHNPH

SEQ ID NO: 156 - protein, 7 aa, Artificial
  Synthetic peptide
NLLPAKL

SEQ ID NO: 157 - protein, 7 aa, Artificial
  Synthetic peptide
HTALSTS

SEQ ID NO: 158 - protein, 7 aa, Artificial
  Synthetic peptide
TPGSGQF

SEQ ID NO: 159 - protein, 12 aa, Artificial
  Synthetic peptide
FSPNNSETTNYT

SEQ ID NO: 160 - protein, 12 aa, Artificial
  Synthetic peptide
TTVPDTWVLFPR

SEQ ID NO: 161 - protein, 12 aa, Artificial
  Synthetic peptide
SNVPLHWILSPR

SEQ ID NO: 162 - protein, 12 aa, Artificial
  Synthetic peptide
WHFEWWRATPSG

SEQ ID NO: 163 - protein, 12 aa, Artificial
  Synthetic peptide
NYPAVVSNSLLA

SEQ ID NO: 164 - protein, 12 aa, Artificial
  Synthetic peptide
DVYDTRPYHGFM

SEQ ID NO: 165 - protein, 12 aa, Artificial
  Synthetic peptide
HQNPWLLWPRGF

SEQ ID NO: 166 - protein, 15 aa, Artificial
  Synthetic peptide
VIDWLLCPRGFSACM

SEQ ID NO: 167 - protein, 15 aa, Artificial
  Synthetic peptide
DRRIFWWSLRSAPGA

SEQ ID NO: 168 - protein, 15 aa, Artificial
  Synthetic peptide
LHAWHRNTIGWWIGF

SEQ ID NO: 169 - protein, 7 aa, Artificial
  Synthetic peptide
WGLWFSN

SEQ ID NO: 170 - protein, 7 aa, Artificial
  Synthetic peptide
WGIWWNN

SEQ ID NO: 171 - protein, 7 aa, Artificial
  Synthetic peptide
WGLWSTP

SEQ ID NO: 172 - protein, 7 aa, Artificial
  Synthetic peptide
WVHLQSP

SEQ ID NO: 173 - protein, 7 aa, Artificial
  Synthetic peptide
WGLWWHT

SEQ ID NO: 174 - protein, 7 aa, Artificial
  Synthetic peptide
WGLWWTG

SEQ ID NO: 175 - protein, 7 aa, Artificial
  Synthetic peptide
LLGLTET

SEQ ID NO: 176 - protein, 7 aa, Artificial
  Synthetic peptide
DSRWLLP

SEQ ID NO: 177 - protein, 12 aa, Artificial
  Synthetic peptide
FHWWPRTQDPHR

SEQ ID NO: 178 - protein, 12 aa, Artificial
  Synthetic peptide
FHWSWYTPSRPS

SEQ ID NO: 179 - protein, 12 aa, Artificial
  Synthetic peptide
HSSWWLALAKPT

SEQ ID NO: 180 - protein, 12 aa, Artificial
  Synthetic peptide
WHWYPRFSPPSH

SEQ ID NO: 181 - protein, 12 aa, Artificial
  Synthetic peptide
NDYSDSNQVPAS

SEQ ID NO: 182 - protein, 12 aa, Artificial
  Synthetic peptide
FHWPRSWVTWQS

SEQ ID NO: 183 - protein, 12 aa, Artificial
  Synthetic peptide
HLSSRHLFVPLS

SEQ ID NO: 184 - protein, 12 aa, Artificial
  Synthetic peptide
TITDCYPICVSP

SEQ ID NO: 185 - protein, 12 aa, Artificial
  Synthetic peptide
WPCHPICLSPRG

SEQ ID NO: 186 - protein, 12 aa, Artificial
  Synthetic peptide
AMDCFPICLWNP

SEQ ID NO: 187 - protein, 12 aa, Artificial
  Synthetic peptide
WNCFPICHASGL

SEQ ID NO: 188 - protein, 12 aa, Artificial
  Synthetic peptide
VYALGCWPICHK

SEQ ID NO: 189 - protein, 12 aa, Artificial
  Synthetic peptide
HHVFTPNCYPIC

SEQ ID NO: 190 - protein, 12 aa, Artificial
  Synthetic peptide
WHWSSLSWPALP

SEQ ID NO: 191 - protein, 15 aa, Artificial
  Synthetic peptide
GNWLFNSCYPLCFPL

SEQ ID NO: 192 - protein, 15 aa, Artificial
  Synthetic peptide
AFLGHSHWFPSVASR

SEQ ID NO: 193 - protein, 15 aa, Artificial
  Synthetic peptide
QLLCFPICRPEPPVS

SEQ ID NO: 194 - protein, 7 aa, Artificial
  Synthetic peptide
WYTKAPY

SEQ ID NO: 195 - protein, 7 aa, Artificial
  Synthetic peptide
WYHKAPY

SEQ ID NO: 196 - protein, 7 aa, Artificial
  Synthetic peptide
YYQRAPY

SEQ ID NO: 197 - protein, 12 aa, Artificial
  Synthetic peptide
HWKHPWGAWDTL

SEQ ID NO: 198 - protein, 12 aa, Artificial
  Synthetic peptide
WHWQWTPWSIQP

SEQ ID NO: 199 - protein, 12 aa, Artificial
  Synthetic peptide
WHKNWWPPSTPN

SEQ ID NO: 200 - protein, 12 aa, Artificial
  Synthetic peptide
SMSSMLLAAQTV

SEQ ID NO: 201 - protein, 12 aa, Artificial
  Synthetic peptide
QSHYRHISPAQV

SEQ ID NO: 202 - protein, 12 aa, Artificial
  Synthetic peptide
SMSQPKSQVNAH

SEQ ID NO: 203 - protein, 12 aa, Artificial
  Synthetic peptide
WHWTFYTPLEST

SEQ ID NO: 204 - protein, 12 aa, Artificial
  Synthetic peptide
ESLSTDTYAILL

SEQ ID NO: 205 - protein, 12 aa, Artificial
  Synthetic peptide
HSSWYIQHFPPL

SEQ ID NO: 206 - protein, 12 aa, Artificial
  Synthetic peptide
STYLNGPTGVDL

SEQ ID NO: 207 - protein, 12 aa, Artificial
  Synthetic peptide
QHKTSITGHLEP

SEQ ID NO: 208 - protein, 12 aa, Artificial
  Synthetic peptide
FHRWPTWPLPSP

SEQ ID NO: 209 - protein, 12 aa, Artificial
  Synthetic peptide
VPPWVSVRTGPG

SEQ ID NO: 210 - protein, 12 aa, Artificial
  Synthetic peptide
TLVYQPPWYRIA

SEQ ID NO: 211 - protein, 12 aa, Artificial
  Synthetic peptide
FHQRLWWPTHTP

SEQ ID NO: 212 - protein, 11 aa, Artificial
  Synthetic peptide
WHWRLYSANTP

SEQ ID NO: 213 - protein, 15 aa, Artificial
  Synthetic peptide
HAAFEPRGDVRHTLL

SEQ ID NO: 214 - protein, 15 aa, Artificial
  Synthetic peptide
SIWDLPLQYRGFGTS

SEQ ID NO: 215 - protein, 15 aa, Artificial
  Synthetic peptide
LWRLRGGSFPVISHG

SEQ ID NO: 216 - protein, 15 aa, Artificial
  Synthetic peptide
RNALHSLRTLSSSWV

SEQ ID NO: 217 - protein, 12 aa, Artificial
  Synthetic peptide
FHRHWWPPTLST

SEQ ID NO: 218 - protein, 12 aa, Artificial
  Synthetic peptide
RPHLLDWELNPV

SEQ ID NO: 219 - protein, 12 aa, Artificial
  Synthetic peptide
FHWRWSTFPEYP

SEQ ID NO: 220 - protein, 12 aa, Artificial
  Synthetic peptide
VWAVSLPWYRYP

SEQ ID NO: 221 - protein, 12 aa, Artificial
  Synthetic peptide
LDTYWYREHFRR

SEQ ID NO: 222 - protein, 12 aa, Artificial
  Synthetic peptide
VHWRWWDQRVPM

SEQ ID NO: 223 - protein, 7 aa, Artificial
  Synthetic peptide
LPWYQLT

SEQ ID NO: 224 - protein, 7 aa, Artificial
  Synthetic peptide
VPWFRAP

SEQ ID NO: 225 - protein, 7 aa, Artificial
  Synthetic peptide
WHPPQPS

SEQ ID NO: 226 - protein, 7 aa, Artificial
  Synthetic peptide
FHENWPS

SEQ ID NO: 227 - protein, 7 aa, Artificial
  Synthetic peptide
FWWQVPA

SEQ ID NO: 228 - protein, 7 aa, Artificial
  Synthetic peptide
TQWYQIA

SEQ ID NO: 229 - protein, 7 aa, Artificial
  Synthetic peptide
LPWFQLP

SEQ ID NO: 230 - protein, 7 aa, Artificial
  Synthetic peptide
TPLSKST

SEQ ID NO: 231 - protein, 7 aa, Artificial
  Synthetic peptide
LPWYATP

SEQ ID NO: 232 - protein, 6 aa, Artificial
  Synthetic peptide
LPWYRH

SEQ ID NO: 233 - protein, 7 aa, Artificial
  Synthetic peptide
IPWYKIT

SEQ ID NO: 234 - protein, 12 aa, Artificial
  Synthetic peptide
FHSTWPWREAEG

SEQ ID NO: 235 - protein, 12 aa, Artificial
  Synthetic peptide
FHANWPQSARDV

SEQ ID NO: 236 - protein, 12 aa, Artificial
  Synthetic peptide
FHSDWPGQTFTW

SEQ ID NO: 237 - protein, 12 aa, Artificial
  Synthetic peptide
FHENWSTRPTTR

SEQ ID NO: 238 - protein, 12 aa, Artificial
  Synthetic peptide
FHSVYPWREAEG

SEQ ID NO: 239 - protein, 12 aa, Artificial
  Synthetic peptide
FHSNWPSAYTAR

SEQ ID NO: 240 - protein, 12 aa, Artificial
  Synthetic peptide
FHSNWPSLIRAR

SEQ ID NO: 241 - protein, 12 aa, Artificial
  Synthetic peptide
AGYQIGMPNPLL

SEQ ID NO: 242 - protein, 12 aa, Artificial
  Synthetic peptide
FHWRYPLPLPGQ

SEQ ID NO: 243 - protein, 12 aa, Artificial
  Synthetic peptide
SPTSFRQVFGFY

SEQ ID NO: 244 - protein, 13 aa, Artificial
  Synthetic peptide
ALPELSSLPESAR

SEQ ID NO: 245 - protein, 12 aa, Artificial
  Synthetic peptide
LHWWPTYGNNGM

SEQ ID NO: 246 - protein, 12 aa, Artificial
  Synthetic peptide
FHRPYYWPPTPL

SEQ ID NO: 247 - protein, 12 aa, Artificial
  Synthetic peptide
FHWRLPYPLPSS

SEQ ID NO: 248 - protein, 12 aa, Artificial
  Synthetic peptide
IHWWVKSPPPGS

SEQ ID NO: 249 - protein, 12 aa, Artificial
  Synthetic peptide
SHWWTSILATPS

SEQ ID NO: 250 - protein, 12 aa, Artificial
  Synthetic peptide
FHWHLQPQLWSY

SEQ ID NO: 251 - protein, 12 aa, Artificial
  Synthetic peptide
LHREWIYPYLIS

SEQ ID NO: 252 - protein, 12 aa, Artificial
  Synthetic peptide
GQKTHNPFHLHP

SEQ ID NO: 253 - protein, 12 aa, Artificial
  Synthetic peptide
ATWSHHLSSAGL

SEQ ID NO: 254 - protein, 12 aa, Artificial
  Synthetic peptide
FHRHYYPWALIQ

SEQ ID NO: 255 - protein, 12 aa, Artificial
  Synthetic peptide
HSLKHTQMSYSS

SEQ ID NO: 256 - protein, 12 aa, Artificial
  Synthetic peptide
SVSVGMKPSPRP

SEQ ID NO: 257 - protein, 12 aa, Artificial
  Synthetic peptide
WPHQVHKHIYRQ

SEQ ID NO: 258 - protein, 12 aa, Artificial
  Synthetic peptide
APPYPGPLPLSL

SEQ ID NO: 259 - protein, 13 aa, Artificial
  Synthetic peptide
AAPPYVFCSLSPR

SEQ ID NO: 260 - protein, 15 aa, Artificial
  Synthetic peptide
TVDLSPAFLFFGRLA

SEQ ID NO: 261 - protein, 15 aa, Artificial
  Synthetic peptide
SLAPYSLRILRVGSA

SEQ ID NO: 262 - protein, 15 aa, Artificial
  Synthetic peptide
RNVLPIFNDVYWIAL

SEQ ID NO: 263 - protein, 15 aa, Artificial
  Synthetic peptide
RNVPPIFNDVYWIAF

SEQ ID NO: 264 - protein, 7 aa, Artificial
  Synthetic peptide
INNTFTW

SEQ ID NO: 265 - protein, 7 aa, Artificial
  Synthetic peptide
YELNLMT

SEQ ID NO: 266 - protein, 12 aa, Artificial
  Synthetic peptide
WGITVETAYGTA

SEQ ID NO: 267 - protein, 12 aa, Artificial
  Synthetic peptide
NQFLLWETRSMR

SEQ ID NO: 268 - protein, 12 aa, Artificial
  Synthetic peptide
NVSLTNLTYKPR

SEQ ID NO: 269 - protein, 12 aa, Artificial
  Synthetic peptide
YTPPDWSWWPAP

SEQ ID NO: 270 - protein, 12 aa, Artificial
  Synthetic peptide
IKNTSLQQLVTA

SEQ ID NO: 271 - protein, 12 aa, Artificial
  Synthetic peptide
EWLAYDGIRAYS

SEQ ID NO: 272 - protein, 12 aa, Artificial
  Synthetic peptide
HAKVQVSSPFPP

SEQ ID NO: 273 - protein, 7 aa, Artificial
  Synthetic peptide
LSSQFKQ

SEQ ID NO: 274 - protein, 7 aa, Artificial
  Synthetic peptide
GTFKWYQ

SEQ ID NO: 275 - protein, 7 aa, Artificial
  Synthetic peptide
TKMDQST

SEQ ID NO: 276 - protein, 12 aa, Artificial
  Synthetic peptide
IPEEALRARFKT

SEQ ID NO: 277 - protein, 12 aa, Artificial
  Synthetic peptide
SFQDALLSRWYS

SEQ ID NO: 278 - protein, 15 aa, Artificial
  Synthetic peptide
SNLRSWLFPFDRVGN

SEQ ID NO: 279 - protein, 15 aa, Artificial
  Synthetic peptide
PGPMFGGSYIPSLHH

SEQ ID NO: 280 - protein, 7 aa, Artificial
  Synthetic peptide
YPQGLWR

SEQ ID NO: 281 - protein, 7 aa, Artificial
  Synthetic peptide
YPQGEWR

SEQ ID NO: 282 - protein, 15 aa, Artificial
  Synthetic peptide
GPSYYALITRYLGAA

SEQ ID NO: 283 - protein, 15 aa, Artificial
  Synthetic peptide
GLSYYALITRYLGAA

SEQ ID NO: 284 - protein, 7 aa, Artificial
  Synthetic peptide
WPPISRH

SEQ ID NO: 285 - protein, 12 aa, Artificial
  Synthetic peptide
AHSWLPGAGLLM

SEQ ID NO: 286 - protein, 12 aa, Artificial
  Synthetic peptide
SLTHSPRTPILA

SEQ ID NO: 287 - protein, 12 aa, Artificial
  Synthetic peptide
FPNLRERHEPLF

SEQ ID NO: 288 - protein, 15 aa, Artificial
  Synthetic peptide
GHSYHALITRYLGAA

SEQ ID NO: 289 - protein, 15 aa, Artificial
  Synthetic peptide
WASYYALITRYLGAA

SEQ ID NO: 290 - protein, 15 aa, Artificial
  Synthetic peptide
DFAQALFLRYVVSGL

SEQ ID NO: 291 - protein, 15 aa, Artificial
  Synthetic peptide
HRWMPHVFAVRQGAL

SEQ ID NO: 292 - protein, 15 aa, Artificial
  Synthetic peptide
WASFYASSYRDSRLL

SEQ ID NO: 293 - protein, 15 aa, Artificial
  Synthetic peptide
RLPATIRALLGRDVR

SEQ ID NO: 294 - protein, 15 aa, Artificial
  Synthetic peptide
RLPATIRALLGRDVW

SEQ ID NO: 295 - protein, 7 aa, Artificial
  Synthetic peptide
VPRHNPI

SEQ ID NO: 296 - protein, 15 aa, Artificial
  Synthetic peptide
PKAFQYGGRAVGGLW

SEQ ID NO: 297 - protein, 15 aa, Artificial
  Synthetic peptide
DSGALFNHIFMPGPF

SEQ ID NO: 298 - protein, 15 aa, Artificial
  Synthetic peptide
LHSSHLPPDDRRWGL

SEQ ID NO: 299 - protein, 15 aa, Artificial
  Synthetic peptide
PRQFPLRDLYTFRYW

SEQ ID NO: 300 - protein, 15 aa, Artificial
  Synthetic peptide
GAANLYVSSFLIPLH

SEQ ID NO: 301 - protein, 15 aa, Artificial
  Synthetic peptide
RNVPPIFNDVYWIAL

SEQ ID NO: 302 - protein, 15 aa, Artificial
  Synthetic peptide
QPRGVTVHGDAWRVA

SEQ ID NO: 303 - protein, 15 aa, Artificial
  Synthetic peptide
GLDLLGDVRIPVVRR

SEQ ID NO: 304 - protein, 15 aa, Artificial
  Synthetic peptide
AYWDLYGVGFAFSAP

SEQ ID NO: 305 - protein, 15 aa, Artificial
  Synthetic peptide
IWTITGSTKQAFDRS

SEQ ID NO: 306 - protein, 15 aa, Artificial
  Synthetic peptide
EDWFSASIRRVPTFA

SEQ ID NO: 307 - protein, 15 aa, Artificial
  Synthetic peptide
AVKLRPSSCWLKSTC

SEQ ID NO: 308 - protein, 15 aa, Artificial
  Synthetic peptide
RFDGIDLRVSFVSRP

SEQ ID NO: 309 - protein, 15 aa, Artificial
  Synthetic peptide
ASLHPVPKTWFSLLS

SEQ ID NO: 310 - protein, 7 aa, Artificial
  Synthetic peptide
LAPPPSP

SEQ ID NO: 311 - protein, 15 aa, Artificial
  Synthetic peptide
AVTFNSYFGFSTTSV

(19) United States
(12) Patent Application Publication
(10) Pub. No.: US 2010/0216661 A1
(43) Pub. Date: Aug. 26, 2010

(54) Diagnostic Assay

(76) Inventors: Stanislaw Joseph Urbaniak, Aberdeen (GB); Michael Terrance Moss, Aberdeenshire (GB); Evelyn Jacqueline Annette Tait, Aberdeen (GB)

Correspondence Address: LICATA & TYRRELL P.C., 66 E. MAIN STREET, MARLTON, NJ, 08053, US

(21) Appl. No.: 12/594,447

(22) PCT Filed: Apr. 3, 2008
(86) PCT No.: PCT/GB08/01200

§ 371 Date: Feb. 25, 2010

(30) Foreign Application Priority Data
Apr. 3, 2007 (GB) 0706558.4

(51) Int. Cl. C40B 30/04; C40B 40/10

(52) U.S. Cl. 506/9; 506/18

(57) ABSTRACT

The present invention relates to mimotopes of blood group antigens, methods for identifying mimotopes of blood group antigens and methods for identifying antibodies to blood group antigens using said mimotopes.

The present invention relates to mimotopes of blood group antigens, and uses thereof.

Blood group antigens exist on membrane proteins on the surface of erythrocytes. The genes encoding all but one of the 29 blood group systems (Rhesus, Kell, Duffy, Kidd, ABO, MNS, P, Lutheran, Lewis, Diego, Yt, Xg, Scianna, Dombrock, Colton, Landsteiner-Wiener, Chido-Rodgers, Hh, Kx, Gerbich, Cromer, Knops, Indian, Ok, Raph, JMH, I, Globoside and GIL) have been cloned, sequenced, the amino acid sequences deduced, and the membrane structure predicted.

Of the Rhesus, Kell, Duffy and Kidd blood systems etc, the Rhesus antigens are the most complex being the products of two highly homologous genes, RHD and RHCE. The antigens are predicted to have six extracellular loops that are available for antibody binding.

The RhD polypeptide, the most commonly expressed of the Rhesus antigens, differs by 36 amino acids from its nearest equivalent, the RhCcEe polypeptide. Both are co-expressed with the Rhesus-associated glycoprotein (RAG) polypeptide.

The RHCE gene product exists in four allelic forms and each allele determines the expression of two antigens in combination i.e. Ce, ce, cE or CE. The RhC antigen differs from Rhc by one amino acid in loop 2 (Ser103Pro), and for E/e, a single exofacial amino acid difference is predicted in loop 4 (Pro226Ala).

The Kell protein is a single pass membrane structure, and the K/k alleles are the result of a single nucleotide polymorphism (SNP) resulting in a single amino acid change (Met193Thr) in the extracellular region.

The Duffy protein is predicted to have 3 extracellular loops with the N-terminus being extracellular, and the Fy^{a}/Fy^{b} alleles are the result of a SNP giving rise to an amino acid substitution (Asp42Gly) in the N-terminal region.

The Kidd glycoprotein is predicted to have 10 membrane-spanning domains with intracellular N- and C-termini. The Jk^{a}/Jk^{b} polymorphism results from a SNP giving rise to a single amino acid substitution (Asp280Asn) on the fourth extracellular loop.

The immunological determinants on an antigen that bind antibodies are defined as B-cell epitopes since they are recognised by the surface-membrane immunoglobulin receptors of B-lymphocytes. These epitopes may be linear i.e. a continuous stretch of amino acids from the protein sequence, or conformational and depend on the spatial juxtaposition of amino acids which are not contiguous. Study of the B-cell epitope structure of blood group antigens has largely been restricted to the RhD antigen, and to date over 30 epitopes have been identified serologically.

A single amino acid substitution can affect more than one epitope, even though the predicted loops involved are some distance apart in the linear sequence, and it is concluded that the RhD B-cell epitopes are conformational.

The B-cell epitopes on C/c and E/e are predicted to be fewer, but are likely to be conformational since full antigenicity requires co-expression of the RAG polypeptide.

The K/k polymorphism is predicted to disrupt a glycosylation site, which may account for the antigenicity of the K allele, and it is anticipated that the epitopic determinants will also be conformational.

Blood group antigens may induce the production of alloantibodies that can cause destruction of transfused red blood cells. Reactions to transfused blood may, therefore, occur when a recipient of transfused erythrocytes has antibodies to those erythrocytes, resulting in their destruction. An immediate reaction including fever, hypotension, nausea and vomiting, and pain in the back and chest can occur, with the severity of the reaction depending on the class and amount of antibodies involved.

Alloantibodies to blood group antigens may also cross the placenta of a pregnant woman and give rise to haemolytic disease of the newborn (HDNB). Haemolytic disease of the newborn (HDNB) can occur when the mother has been sensitised to antigens on the infant's erythrocytes and makes IgG antibodies to these antigens. These antibodies can cross the placenta and react with the foetal erythrocytes causing their destruction. RhD is the most commonly involved antigen.

Blood group antigens may also induce the production of autoantibodies involved in autoimmune diseases such as autoimmune haemolytic anaemia. The trigger for this autoimmune disease is unknown and therefore it may occur at anytime and results in the body producing autoantibodies of broad Rh group specificity which attack the body's own red blood cells.

The most important blood groups associated with alloantibody generation are Rhesus, Kell, Duffy, and Kidd.

Current methods for detecting alloantibodies that may destroy transfused erythrocytes or cross the placenta to cause HDNB, or for detecting autoantibodies, rely on blood donor red cell reagents. These have a short shelf-life and vary considerably in the antigen expression between donors. Use of human blood products also introduces safety implications, for example, involving the potential transfer of viral infections. The rigorous testing and screening required when using human reagents, together with inconsistencies between samples slows the availability of reagents for detecting alloantibodies, as well as increasing the cost of obtaining suitable reagents.

The present invention, accordingly, seeks to overcome the problems associated with the prior art, in particular, the problems associated with existing methods for detecting alloantibodies and autoantibodies.

According to an aspect of the present invention there is provided a mimotope of a blood group antigen.

The term “mimotope” refers to a peptide which is capable of mimicking an epitope of a native peptide. Usually such peptides are synthetic peptides. In this respect, “synthetic peptide” includes any peptides which are synthesised rather than expressed natively in a biological system. Synthesis may be by recombinant technology such as phage display, F-moc chemistry or any other method for expressing or synthesising foreign peptides in biological or non-biological systems or environments.

The present invention thus provides novel peptides which are capable of binding to antibodies which have been raised to blood group antigens. These peptides are not necessarily from natural sources such as human blood and, therefore, do not carry the health risks, storage problems and variability associated therewith.

Conveniently, the blood group antigen is selected from Rhesus, Kell, Duffy, Kidd, ABO, MNS, P, Lutheran, Lewis, Diego, Yt, Xg, Scianna, Dombrock, Colton, Landsteiner-Wiener, Chido-Rodgers, Hh, Kx, Gerbich, Cromer, Knops, Indian, Ok, Raph, JMH, I, Globoside or GIL.

The deduced amino acid structure of a mimotope may not necessarily correspond to the amino acid structure of the antigen which it mimics. Indeed, in the present study it was discovered that the majority of the blood group mimotopes identified have amino acid sequences which differ widely from the amino acid sequence of the native antigen that they mimic.

As the epitopes of many blood group antigens are thought to be complex in conformation, it is surprising that the synthetic peptides, identified in the present invention by means of immunopanning, are capable of binding antibodies raised to native antigens in a specific manner. This finding suggests that the synthetic blood group mimotopes assume and maintain a three dimensional conformation which allows them to specifically bind the antibodies raised to their corresponding antigen.

Conveniently, the mimotope is synthesised. This removes the problems associated with using human blood reagents, for example, the potential risk of contamination and infection, difficulties regarding storage, donor identification, variability and screening. These problems have associated costs which will be reduced through use of synthetic mimotopes. Use of synthetic mimotopes also provides a greater degree of control over the reagents that are available for use, ensuring that shortages never occur and unnecessary waiting for reagents can be avoided.

Through the present study, numerous mimotopes of blood group antigens were identified. Some of the peptides conveniently identified as blood group mimotopes are identified in Tables 2-5 and include peptide fragments, immunoreactive analogues or derivatives thereof.

According to a further aspect of the present invention there is provided a method for identifying a mimotope of a blood group antigen, the method comprising contacting a random phage display library with an antibody to a blood group antigen and detecting binding of the antibody to peptides in the phage display library, wherein binding of an antibody to a peptide is indicative of the peptide being a mimotope of a blood group antigen.

Preferably, the blood group antigen is Rhesus, Kell, Duffy, Kidd, ABO, MNS, P, Lutheran, Lewis, Diego, Yt, Xg, Scianna, Dombrock, Colton, Landsteiner-Wiener, Chido-Rodgers, Hh, Kx, Gerbich, Cromer, Knops, Indian, Ok, Raph, JMH, I, Globoside or GIL. These are the blood group antigens associated with the generation of alloantibodies and autoantibodies.

The antibody to which the mimotope binds may be a monoclonal antibody or a preparation of polyclonal antibodies. Methods for generating monoclonal antibodies and polyclonal antibodies are well known in the art.

Random phage display libraries comprising 7-mer, 12-mer and 15-mer peptides were used to identify peptides which could bind antibodies raised to native blood group antigens. Identification and sequencing of peptides which bound to the antibodies enabled identification of potential blood group antigen mimotopes. Subsequent analysis of these peptides by ELISA followed by synthesis of these peptides by SPOTs and analysis of the membrane-bound SPOTs confirmed the strength and specificity of the peptide-antibody binding. This confirmed that synthetic peptides structurally different from the native antigens which they mimicked were successfully able to specifically bind antibodies raised to native blood group antigens, thus representing effective mimotopes of the blood group antigens in question. Immobilisation of the mimotopes onto, for example, microsphere beads or superparamagnetic beads did not affect the ability of the mimotopes to specifically bind antibodies raised to native blood group antigens. The method described therefore represents an effective and efficient method for identifying synthetic mimotopes of blood group antigens which can be used in a clinical setting, for example, in the diagnosis of diseases associated with the production of alloantibodies or autoantibodies.

Binding of antibodies to the phage-peptides may be detected by any means suitable, such means being known to a person skilled in the art. Examples of the type of binding which can be used is described in the Examples.

According to a further aspect of the present invention there is provided a method for detecting an antibody to a blood group antigen in a sample. The method comprising reacting a mimotope of said blood group antigen with the sample to be tested, detecting any reaction between the sample and the mimotope, wherein a reaction between the sample and the mimotope is indicative of the presence of an antibody to the blood group antigen.

Conveniently before carrying out the above identified method the mimotope is immobilised on a solid support. Immobilisation of the mimotopes onto a solid support such as, microsphere beads or superparamagnetic beads did not affect the ability of the mimotopes to specifically bind antibodies raised to native blood group antigens. In this connection, the method comprises immobilising a mimotope of a blood group antigen on a solid support, contacting the immobilised mimotope with the sample to be tested and detecting binding of the sample to the mimotope, wherein binding of the sample to the mimotope is indicative of the presence of an antibody to the blood group antigen mimicked by the mimotope.

Conveniently, the blood group antigen is Rhesus, Kell, Duffy, Kidd, ABO, MNS, P, Lutheran, Lewis, Diego, Yt, Xg, Scianna, Dombrock, Colton, Landsteiner-Wiener, Chido-Rodgers, Hh, Kx, Gerbich, Cromer, Knops, Indian, Ok, Raph, JMH, I, Globoside or GIL.

In this respect, given that many epitopes of native blood group antigens are thought to be conformational it is surprising that the synthetic mimotopes identified herein are capable of presenting a three dimensional conformation which specifically bind antibodies raised to native blood group antigens, even when bound to a solid support. The solid support may comprise any support suitable for the purpose but conveniently comprises a membrane, glass slide or bead (glass, polystyrene etc.). Attachment to the support can be by any suitable means, for example using Ni-NTA groups attached to the surface of polystyrene microsphere beads or using superparamagnetic polystyrene beads. Polyhistidine tags may be incorporated into the C-terminal or N-terminal of mimotopes to aid attachment to the support. Membranes having a lower background and which can be successfully stripped and re-probed, for example INTAVIS AG membranes, are preferable.

The present invention, therefore, provides a method which effectively identifies antibodies in biological samples that have been raised to blood group antigens. Use of synthetic mimotopes removes the problems identified with regard to use of human reagents. This will increase consistency in antibody detection and enable detection of rarer antibodies for little or no extra cost, compared with existing techniques for screening antibodies raised to blood group antigens. Avoiding use of human blood products also increases safety, avoids the rigorous testing required when using human blood products and increases the consistency of the reagents available for use. This reduces the cost of sourcing and clearing reagents for use. The method described is therefore more reliable, safe and convenient than existing detection methods, making detection of antibodies to blood group antigens in biological samples quicker, cheaper and easier to conduct.

The antibodies detected may be alloantibodies or autoantibodies to blood group antigens. The method described, therefore, provides improved methods of detecting and diagnosing diseases or a reaction to blood product's involving the generation of alloantibodies or autoantibodies. Such diseases include haemolytic reactions to red cell transfusions (HTR), haemolytic disease of the newborn and autoimmune haemolytic anaemia.

Conveniently, the antibody is an alloantibody, allowing one to reliably and safely diagnose the risk of HTR or haemolytic disease of the newborn.

According to another aspect of the present invention there is provided a device for detecting the presence of an antibody in a sample to a blood group antigen. The device comprising a solid support (membrane, glass slide, microarray chip or bead(s) etc.) having an array of mimotopes of a blood group antigen immobilised thereon or having one mimotope on each solid support and having provided a plurality of solid supports.

An array may be constructed comprising only Rhesus, Kell, Duffy, Kidd, ABO, MNS, P, Lutheran, Lewis, Diego, Yt, Xg, Scianna, Dombrock, Colton, Landsteiner-Wiener, Chido-Rodgers, Hh, Kx, Gerbich, Cromer, Knops, Indian, Ok, Raph, JMH, I, Globoside or GIL antigen mimotopes. Alternatively, an array may be developed comprising any combination of blood group mimotopes, with mimotopes from multiple blood groups being arranged on the same diagnostic array. The composition and design of the array may depend on the intended purpose of the device and bespoke arrays may be developed as required. Arrays required for specific purposes can be constructed quickly, reliably and cost-effectively, without having to consider the availability of reagents.

With regard to the construction of arrays, different types and length of spacer for attaching peptides to a solid membrane support can be used, for example an amino-PEG spacer or a limited number of amino acid residues could be used to link the mimotope peptide sequence to the solid support.

Conveniently, the antibody is an alloantibody. The device can therefore be used for detecting alloantibodies in a sample of blood obtained from a patient suspected of generating alloantibodies to blood group antigens, without requiring the use of human blood group reagents. Removal of the need for blood group reagents will conveniently increase the availability of reagents for detection of antibodies in blood group samples.

Antigen-capture systems as described herein can also increase the sensitivity and accuracy of antibody detection, thus providing an improvement over existing methods for the detection of blood group.

By showing that phage-peptides, selected by biopanning, specifically bind the antibodies originally used to identify them, the experiments described herein confirm the potential value of the selected phage-peptides as diagnostic reagents.

The mimotopes identified in the present study, when coupled to a suitable solid phase, can be used as screening reagents to detect antibodies to blood group antigens.

In this respect, the mimotopes may be used to diagnose diseases associated with blood group antigens, such as diseases associated with the production of alloantibodies or autoantibodies.

Further potential uses of the mimotopes identified and described herein, together with uses of the arrays formed therewith, will be evident to a person skilled in the art.

The present invention will now be described by way of illustration only with reference to the accompanying drawings:

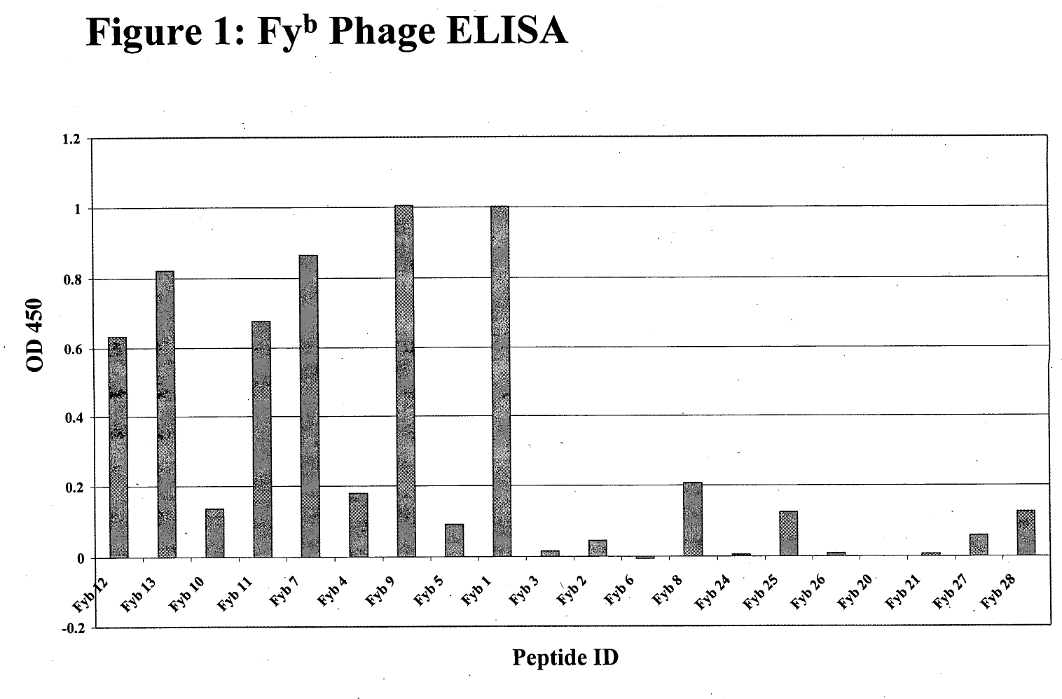

FIG. 1 shows the results of phage ELISA, confirming binding of the anti-Fy^{b} antibody (LM447) to 14 of 20 Fy^{b} phage-peptides assayed.

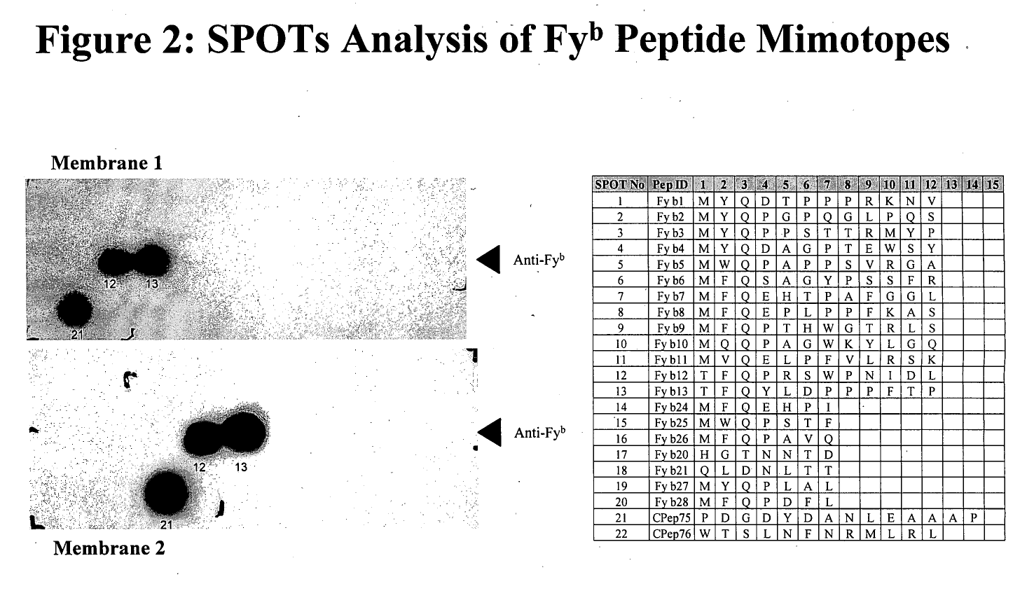

FIG. 2 shows the results of SPOTs hybridisation experiments. 20 Fyb peptide mimotopes were synthesised in duplicate. Binding experiments confirmed the ability of Fyb peptide mimotopes to recognise and bind the anti-Fy^{b} antibody, when synthesised on a membrane support.

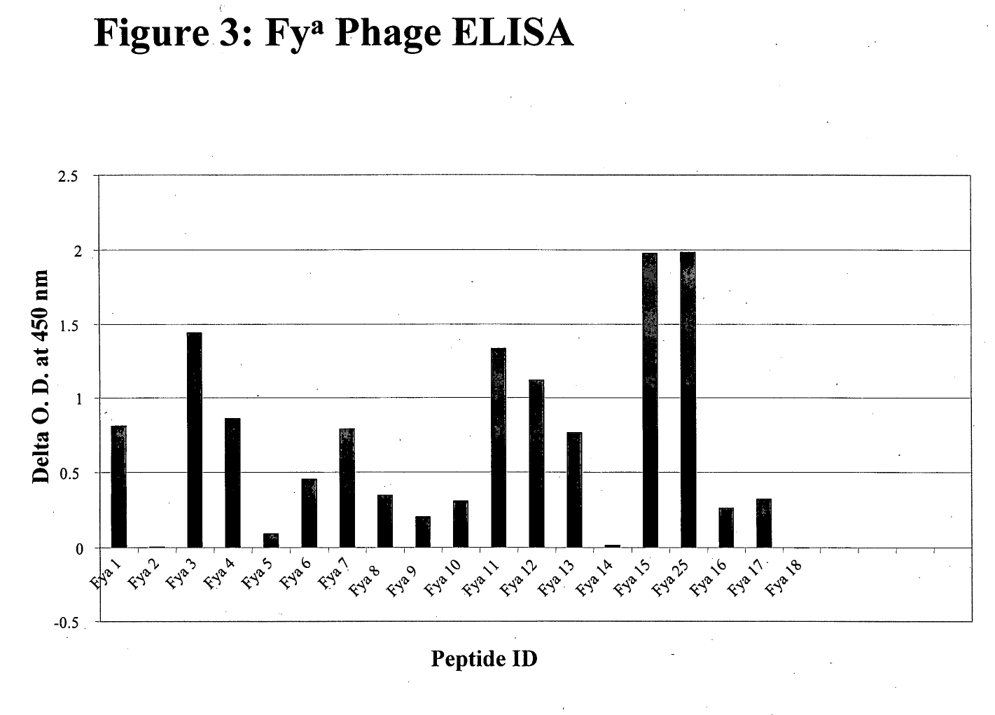

FIG. 3 shows the results of phage ELISA, confirming binding of the anti-Fy^{a} antibody (LM487) to 16 of 19 Fya phage-peptides assayed.

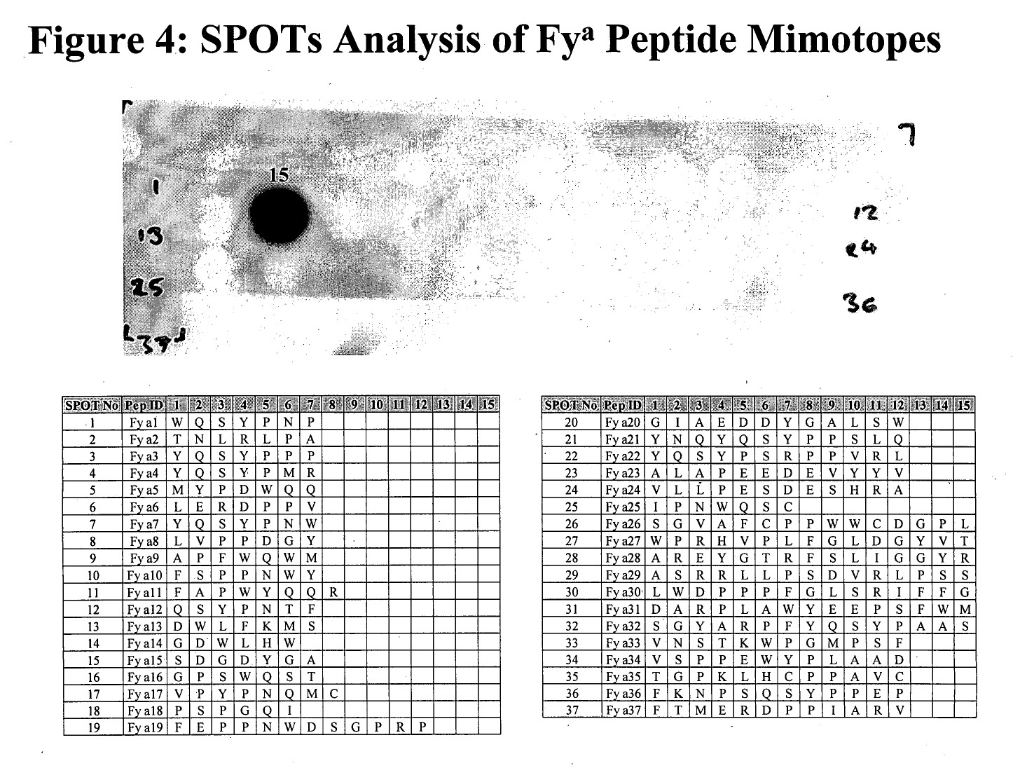

FIG. 4 shows the results of a SPOTs hybridisation experiment. A series of 37 Fya peptide mimotopes were synthesised on a membrane and tested for their ability to bind the anti-Fy^{a} antibody (LM487).

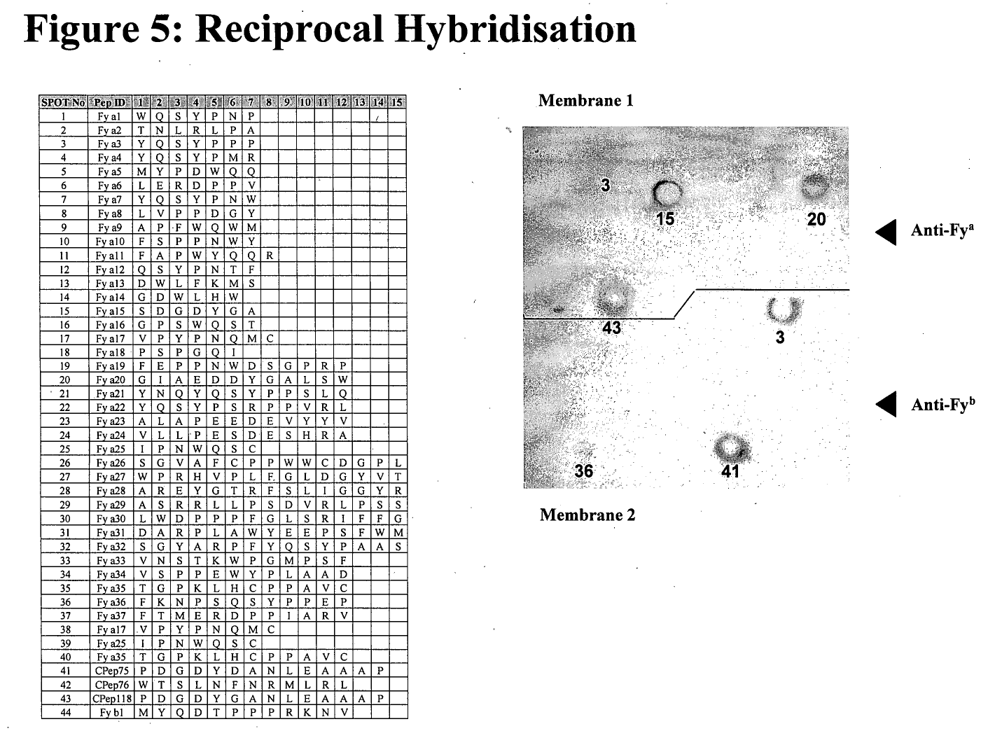

FIG. 5 shows the results of reciprocal hybridisation of Fya peptide mimotopes with the anti-Fy^{a} and anti-Fy^{b} monoclonal antibodies, LM447 and LM487. A series of Fya and peptide mimotopes were synthesised in duplicate and hybridisation of the membranes with the 2 monoclonals identified antibody-specific and cross-reactive peptide mimotopes.

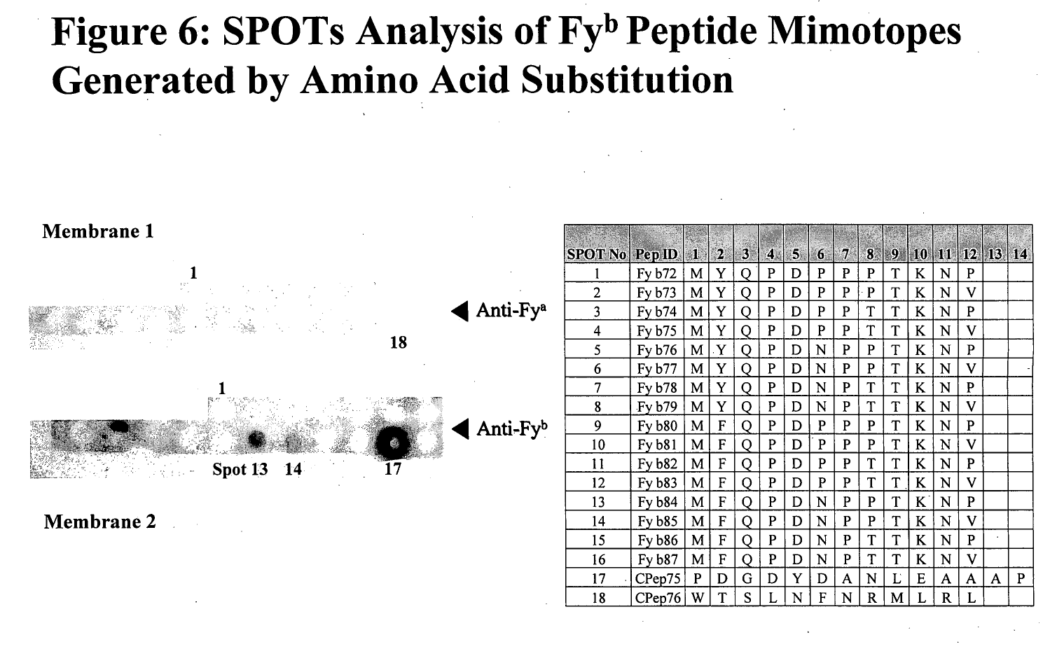

FIG. 6 shows the results of amino acid substitution experiments. A series of 16 synthetic peptides were synthesised in duplicate by SPOTs. These sequences were derived from the Fyb Consensus I sequence and generated by amino acid substitution. The synthetic peptide mimotopes were tested for their ability to bind the anti-Fy^{a} and anti-Fy^{b} monoclonal antibodies.

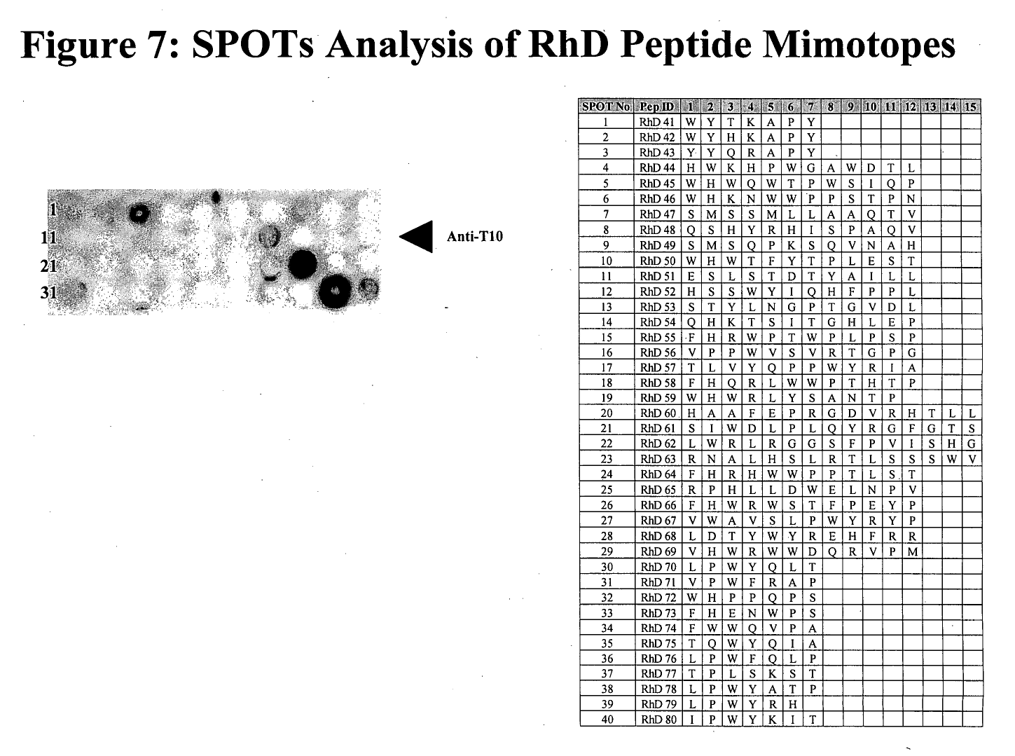

FIG. 7 shows the results following hybridisation of a subset of the anti-RhD antibody-selected peptide mimotopes with the monoclonal antibody T10. 40 peptides (RhD41-RhD80) were synthesised and positive signals were observed in 11 spots (Spots 1-3, 8, 17, 27, 28, 31, 37, 39 & 40; see Table for peptide sequences).

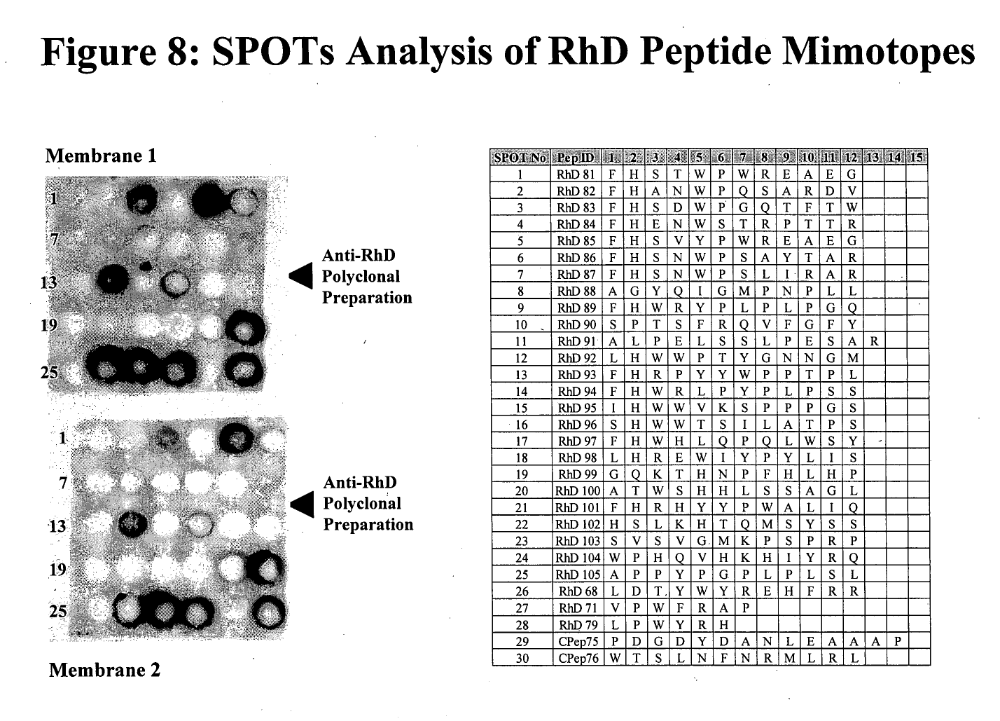

FIG. 8 shows the results of a SPOTs hybridisation experiment. A series of 28 RhD peptide mimotopes were synthesised by SPOTs and hybridisation of the membrane with the polyclonal anti-RhD antisera preparation identified antibody-reactive peptides.

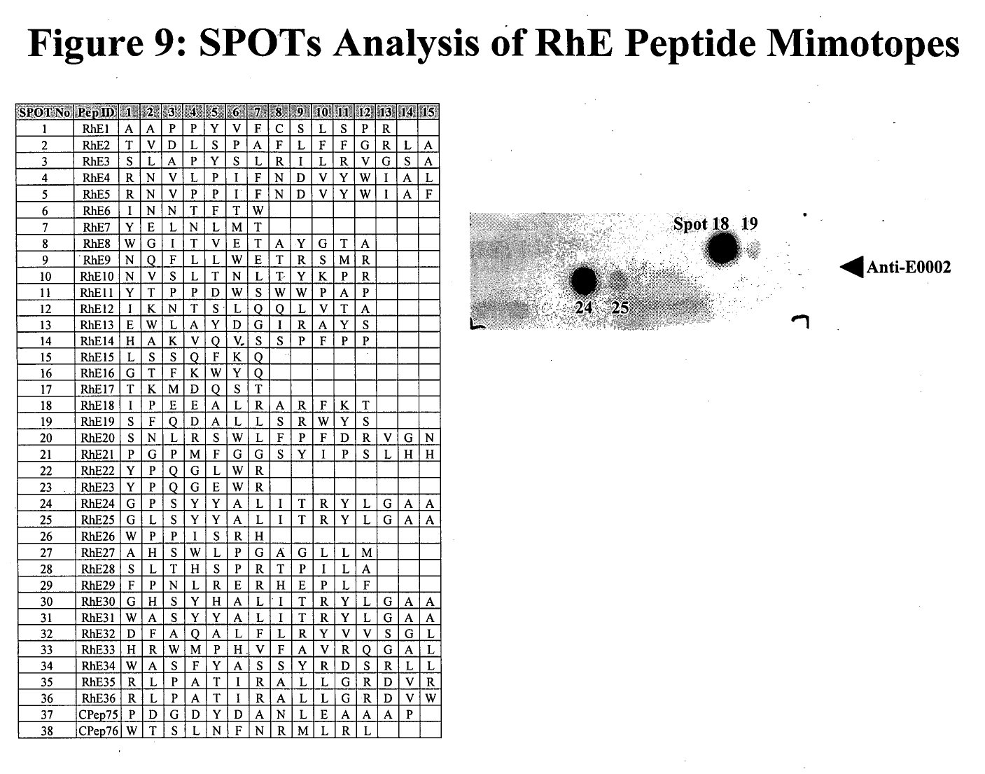

FIG. 9 shows the results of a SPOTs hybridisation experiment. A series of 36 RhE peptide mimotopes were, synthesised by SPOTs. Hybridisation of the membrane with the monoclonal antibody E0002 identified antibody-specific peptide mimotopes.

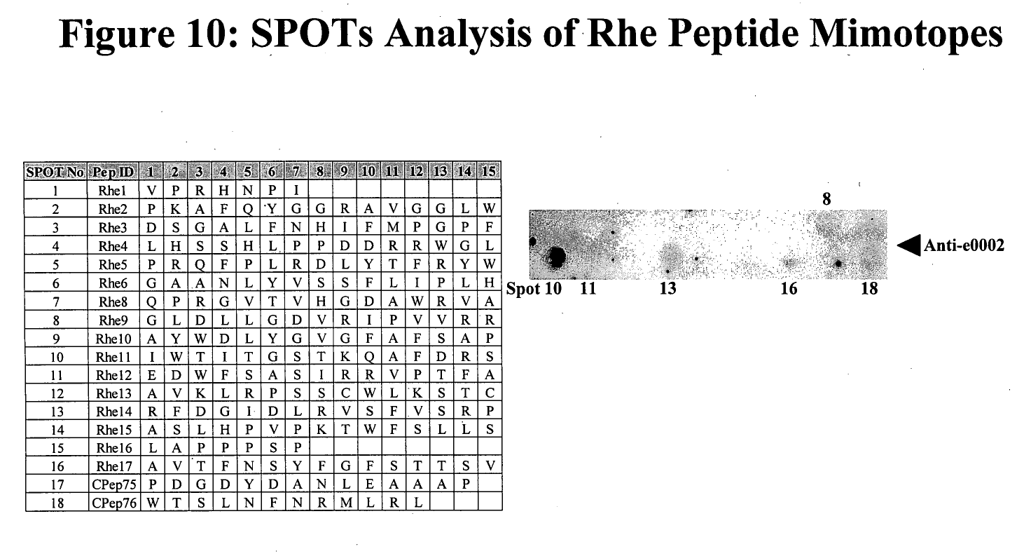

FIG. 10 shows the results of a SPOTs hybridisation experiment. A series of 16 Rhe peptide mimotopes were synthesised by SPOTs. Hybridisation of the membrane with the monoclonal antibody e0002 identified antibody-specific peptide mimotopes.

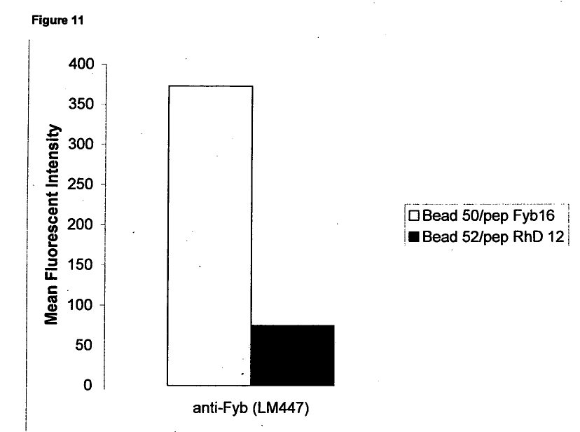

FIG. 11 shows specific binding of anti-Fy^{b} monoclonal antibody (LM447) binding to peptide mimotope Fyb16 immobilised onto polystyrene LiquiChip Ni-NTA microsphere beads. The intensity of the signal equates to the quantity of monoclonal antibody bound to the immobilised peptide mimotope.

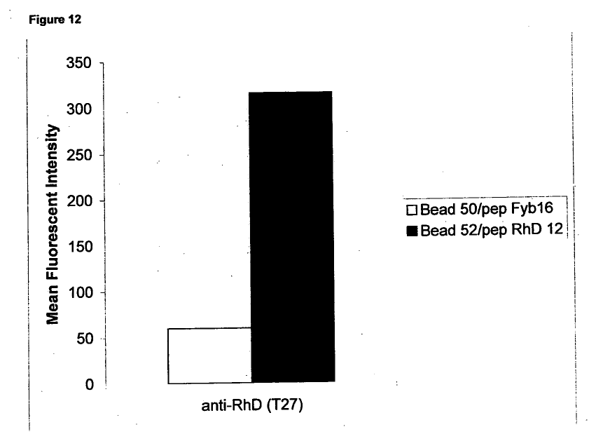

FIG. 12 shows specific binding of anti-RhD monoclonal antibody (T27) binding to peptide mimotope RhD12 immobilised onto polystyrene LiquiChip Ni-NTA microsphere beads. The intensity of the signal equates to the quantity of monoclonal antibody bound to the immobilised peptide mimotope.

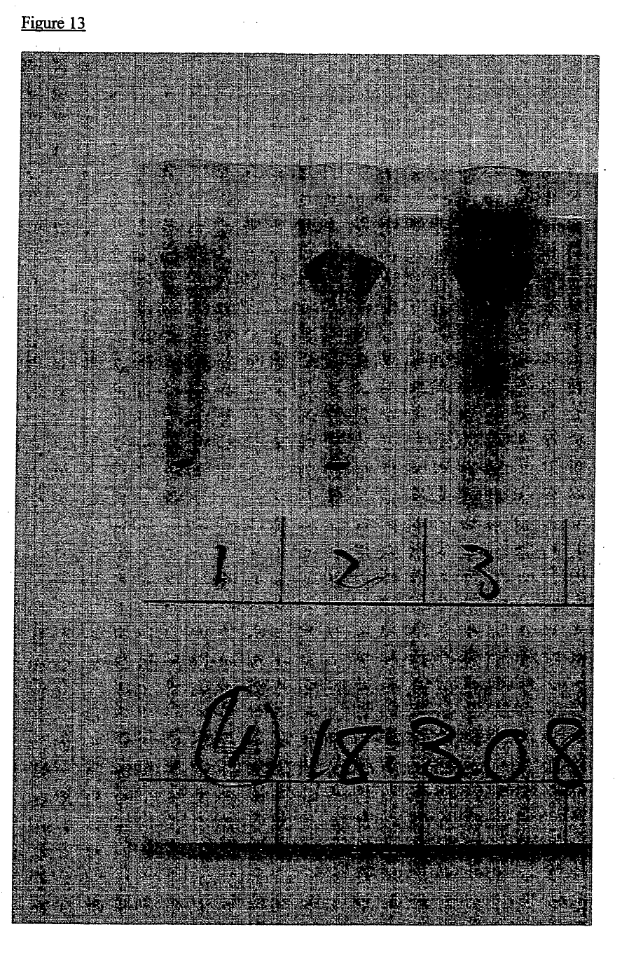

FIG. 13 shows the specific binding of the anti-RhD monoclonal antibody (T27) to peptide mimotope RhD12 immobilised onto superparamagnetic polystyrene beads in a modified gel agglutination assay. Chamber 1: Beads+His-tagged peptide mimotope RhD12 only; Chamber 2: Beads+His-tagged RhD12+anti-Fy^{b} monoclonal antibody (LM447); Chamber 3: Beads+His-tagged RhD12+anti-RhD monoclonal antibody (T27).

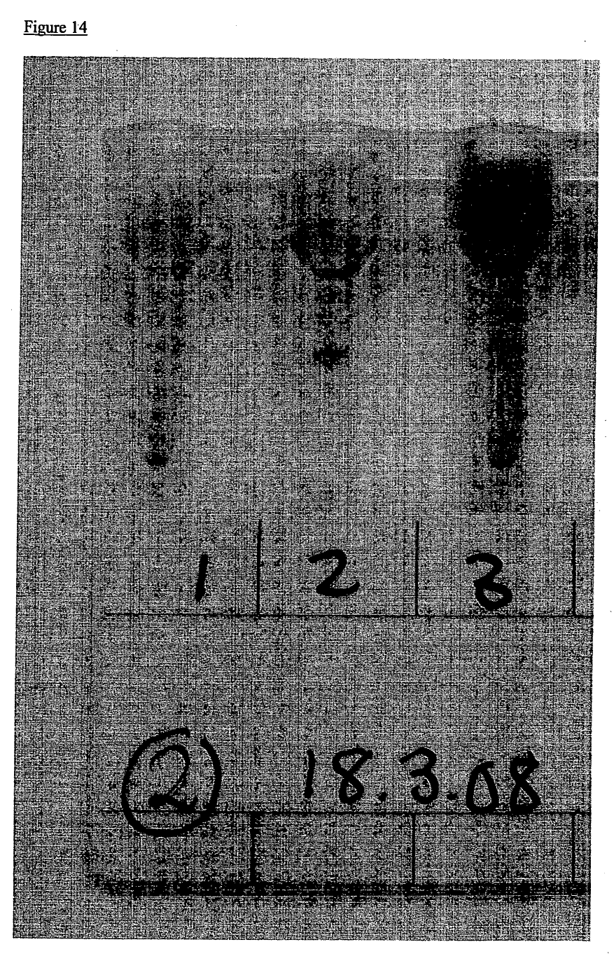

FIG. 14 shows the specific binding of the anti-Fy^{b} monoclonal antibody (LM447) to peptide mimotope Fyb16 immobilised onto superparamagnetic polystyrene beads in a modified gel agglutination assay. Chamber 1: Beads+His-tagged peptide mimotope Fyb16 only; Chamber 2: Beads+His-tagged Fyb16+anti-Fy^{b} monoclonal antibody (LM447); Chamber 3: Beads+His-tagged Fyb16+anti-RhD monoclonal antibody (T27).

### EXAMPLES

### Methodology

Identification of mimotopes of blood group antigens commenced with biopanning of four phage-peptide libraries with a series of blood group antigen-specific monoclonal antibodies (3× anti-RhD, 3×RhE, 2×Rhe, 1×Fy^{a}, 1×Fy^{b}) and an RhD polyclonal preparation. In total, 490 phage were selected and initially characterised by DNA sequencing and ELISA. DNA sequence analysis identified 295 unique phage-peptide sequences, which were synthesised on membranes by SPOTS technology. The specificity of the peptide/antibody reaction was tested by ELISA and SPOTS assays and identified 84 peptides capable of detecting specific RhD, RhE, Rhe, Fy^{a} & Fy^{b} antibodies.

Biopanning

Three different phage libraries from New England Biolabs. (Ph.D. 7 and Ph.D. 12 displaying linear 7- and 12-mer peptides, respectively and Ph.D. C7C displaying 7-mer peptides constrained by a disulphide bridge at their termini) and a linear 15mer library (kindly provided by Prof. George P. Smith, University of Missouri) were used in biopanning experiments with 10 different monoclonal antibodies and a polyclonal preparation (Table 1).

TABLE 1
Antibodies Used in Biopanning.

| Specificity | Epitope | Class | ID | Source |
|---|---|---|---|---|
| Anti-RhD | epD3 [3.1] | IgGI/κ | T10 (LHM76/55) | Human |
| Anti-RhD | epD6/7 [6.3] | IgGI/λ | T22 (LHM 169/80) | Human |
| Anti-RhD | epD1 [1.2] | IgGI/κ | T27 (LHM169/81) | Human |
| Anti-RhD | Polyclonal | — | Human Anti-D Ig | Human |
| Anti-RhE | Not known | IgG1 | E0001 (HIRO17) | Human |
| Anti-RhE | Not known | IgM | E0002 | Human |
| | | | (NaTH110-1D6) | |
| Anti-RhE | Not known | IgM | E0003 | Human |
| | | | (NaTH110-IH4) | |
| Anti-Rhe | Not known | IgM | e0002 (MS62) | Human |
| Anti-Rhe | Not known | IgM | e0003 (MS69) | Human |
| Anti-Fy^{a} | Not known | IgG1 | LM487 | Murine |
| Anti-Fy^{b} | Not known | IgG1 | LM447 | Murine |

All monoclonal antibodies listed were purified from culture supernatants. Polyclonal anti-RhD preparation was obtained from the Scottish National Blood Transfusion Service.

For each target antibody/library combination, a separate well of a 96-well Immulon 4 flat-bottomed ELISA plate (Thermo Labsystems) was coated with 5 μg of antibody in 150 μl ELISA coating buffer (15 mM Na₂CO₃, 35 mM NaHCO₃, pH9.6). Plates were sealed and incubated at 4° C. overnight. Unbound antibody was discarded and 350 μl of blocking buffer (0.1M NaHCO₃/3% skimmed milk powder) was added to each well. Plates were sealed and incubated for 1 hour at 4° C. The blocking buffer was removed and the wells were washed six times with 300 μl TBS/0.1% Tween 20. Approximately 2×10¹¹ plaque forming units (pfu) in 100 μl TBS/0.1% Tween 20 were added to each well and the plates were incubated at room temperature for 1 hour. Wells were washed ten times with 300 μl TBS/0.1% Tween 20. Bound phage were eluted by incubation with 100 μl of 0.2M glycine-HCl/BSA, pH2.2 (1 mg/ml) for 10 minutes, then neutralised with 15 μl of 1M Tris-HCL (pH9.1). An aliquot of the Round 1 eluate was removed and titred. The remainder of the eluted phage were amplified by infection of E. coli ER2538 cells for 4.5 hours at 37° C. The cultures were centrifuged for 10 minutes at 10,000 rpm at 4° C. The supernatants were recovered, ⅙ volume PEG/NaCl (20% polyethylene glycol 8000; 2.5M NaCl) added, then incubated overnight at 4° C. The PEG-precipitated phage were centrifuged at 10,000 rpm for 15 minutes at 4° C. The supernatant was removed and the phage pellet resuspended in 200 μl TBS. Two further rounds of panning were undertaken and approximately 2×10¹¹ pfu of the Round 2 or Round 3 amplified eluates were used as input phage. Round 3 eluates were titrated but not amplified. Individual plaques were amplified and subjected to PCR amplification, prior to DNA sequence analysis. The specificity of peptide-antibody binding was subsequently determined using both phage ELISA and SPOTs techniques.

Phage Culture

Individual phage clones were randomly selected from the Round 3 titration plates and amplified in 1 ml volumes of 1:100 dilution of an overnight culture of E. coli ER2538, grown in L-Broth. Cultures were incubated at 37° C. for 4.5 hours, then centrifuged at 13000 rpm for 1 minute. The phage supernatants were recovered for further analysis by PCR amplification, DNA sequencing and phage ELISA.

PCR Amplification

To determine the peptide sequences displayed in each of the selected phage clones, the DNA insert encoding the peptide sequence was obtained by PCR. PCR amplification was performed in a final volume of 25 μl containing 1× buffer (Bioline), 400 μM dNTPs, 1.5 mM MgCl₂, 1 unit of Taq DNA polymerase (Bioline), 1 μl of phage culture supernatant and 0.5 μM each of the appropriate forward and reverse primers. The primers 12MER1For: 5-CGCAATTCCTTTAGTGGTAC-3 and 12MER2Rev: 5-CCCTCATAGTTAGCGTAACG-3 were used for amplification of the C7C, linear 7-mer and 12-mer phage/peptides. The primers Fuse5For1: 5′-ACCGATACAATTAAAGGCTC-3′ and Fuse5Rev1: 5′-TGAATTTTCTGTATGAGG-3′ were used for the amplification of the 15-mer phage/peptides. PCR was carried out in a thermal cycler (Techgene, model FTGene2D; Techne, Cambridge, UK) under the following conditions: denaturation at 95° C. for 1 minute; annealing at 55° C. for 1 minute; and extension at 72° C. for 3 minutes. After 30 cycles, extension was continued at 72° C. for an additional-9 minutes. PCR products were recovered using the QIAquick PCR Purification Kit (Qiagen) for sequence analysis.

Sequence Analysis

The nucleotide sequences of the phage peptides were obtained using the BigDye Terminator Cycle Sequencing Ready Reaction Kit and an ABI Prism 377 DNA Sequencer (Applied Biosystems). Primer 12MER2Rev was used to determine the random peptide sequences of the C7C, linear 7-mer and 12-mer PCR products. Primer Fuse5Rev1 was used for the 15-mer PCR products. Amino acid sequences were deduced from the nucleotide sequences using Lasergene software (DNASTAR Inc., Wisconsin, USA).

Phage ELISA

The ability of the recovered phage-peptides to react with the antibodies used in their selection was confirmed by capture ELISA. A 10 μg/ml stock of appropriate monoclonal antibody was prepared in ELISA coating buffer and 150 μl aliquots were added to wells of an Immulon 4 ELISA plate, and then incubated overnight at 4° C. Unbound antibody was discarded and the wells were blocked with 350 μl of blocking buffer (0.1M NaHCO₃/3% skimmed milk powder) for 1 hour at 4° C. The wells were washed three times with 300 μl TBS/0.5% Tween 20 and 100 μl of selected phage culture supernatants were added to appropriate wells for 1 hour at room temperature. Unbound phage were removed and the wells washed six times with 300 μl TBS/0.5% Tween 20. A 1:5000 dilution of horseradish peroxidase (HRP) conjugated anti-M13, secondary antibody was prepared in blocking buffer and 100 μl aliquots added to each well. Following incubation for 1 hour at room temperature the wells were washed six times with 300 μl TBS/0.5% Tween 20. To develop the reactions, a 200 μl aliquot of o-phenylenediamine dihydrochloride (OPD) substrate (Sigma) was added to each well. The absorbance at 450 nm was measured, following incubation at room temperature for 1 hour, by a microplate ELISA reader. An OD450 signal greater than 0.1 was considered positive.

SPOT Synthesis

The peptide mimotopes were synthesised by the SPOT method (Frank; 1992) using F-moc chemistry. The peptides were anchored to an amino-PEG derivatised cellulose membrane (Intavis AG) and synthesised as discrete spots. Synthesis was by stepwise elongation of the peptide chain from C-terminus to the N-terminus, by manual pipetting of the respective amino acids, according to the Sigma Genosys protocol. Incubation times were modified when using Intavis AG membranes. After addition of the final amino acid, the terminal residues and side chains of the peptides were deprotected and the membrane was washed with methanol; air dried and then stored at −20° C. prior to use.

Screening of SPOT Membranes

A membrane was placed in a 50 ml Falcon tube and blocked overnight at 4° C. with gentle agitation in TBS/0.25% Tween 20/5% skimmed milk powder. A 2 μg/ml dilution of the primary (1°) antibody (monoclonal or polyclonal) was prepared in TBS/0.25% Tween20/5% skimmed milk powder before incubation with the membrane for 1 hour at room temperature on a spiral rotor. Following 4 washes, each for 5 minutes with 20 ml of TBS/0.25% Tween20, the membrane was incubated for 1 hour at room temperature with a 1/5000 dilution of the secondary (2°) antibody, prepared in TBS/0.25% Tween20/5% skimmed milk powder. Peroxidase labelled rabbit anti-mouse IgG (Sigma) was used for the detection of the murine anti-Fy^{a} (LM487) and anti-Fy^{b} (LM447) 1° antibodies and peroxidase labelled goat anti-human IgG (Pharmacia) for the detection of the human 1° antibodies. Following 4 washes, each for 5 minutes with 20 ml of TBS/0.25% Tween20, the membrane was blotted to remove excess fluid. Bound antibody was detected by chemiluminescence. ECL detection reagents (Amersham Biosciences) were mixed and overlaid on the membrane for 2 minutes. The chemiluminescent substrate was removed and the membrane blotted to remove excess fluid. Positive spots were visualised following exposure to Hyperfilm ECL (Amersham Biosciences) for a series of short incubation times (5 seconds to 10 minutes).

### Example 1

### Identification of Phage-Peptides which Mimic the Duffy Antigenic Epitopes

The anti-Fy^{a} (LM487) and anti-Fy^{b} (LM447)-specific monoclonal antibodies were developed using immunogenic peptides derived from epitopes on the Duffy glycoprotein (Colligan et al, 1998). These antibodies were used to pan phage libraries for peptides that mimicked the native Duffy antigens. Clones from the final third round of each panning experiment were chosen at random for amplification and DNA sequencing. The amino acid sequences encoded by the phage-peptides were deduced from the DNA sequence data.

Biopanning of each of the 4 phage-peptide libraries was undertaken with the anti-Fy^{b} monoclonal antibody (LM447) and resulted in the identification of multiple copies of particular sequences from each of the libraries. In total, 100 unique Fyb peptide mimotopes were identified (see Table 2/peptides Fyb1-71 & Fyb88-116). None of the sequences identified resembled the 14-mer immunisation peptide (PDGDYDANLEAAAP; CPep75) used in the development of the LM447 antibody. However, analysis of the amino acid sequences of these “Fyb” peptide mimotopes identified 2 consensus sequences:

Consensus 1:
M(F/Y)QPD(N/P) (P/L) (T/P)T(K/L) (N/Q) (P/V/A/S)
Consensus 2:
D(H/M/V)HYT(S/N)NTDPL(H/N/R) (A/P/V)P

Certain positions within each consensus sequence had a limited number of amino acids (shown in brackets). These occurred with equal frequency amongst the total population of Fyb peptide mimotopes selected.

TABLE 2
Fyb peptides

| SEQ | | | | | | | | | | | | | | | | | |
|---|---|---|---|---|---|---|---|---|---|---|---|---|---|---|---|---|---|
| ID | | Panning | | | | | | | | | | | | | | | |
| NO: | Pep ID | Antibody | 1 | 2 | 3 | 4 | 5 | 6 | 7 | 8 | 9 | 10 | 11 | 12 | 13 | 14 | 15 |
| 1 | Fy b1 | Fy^{b} | M | Y | Q | D | T | P | P | P | R | K | N | V | | | |
| 2 | Fy b2 | Fy^{b} | M | Y | Q | P | G | P | Q | G | L | P | Q | S | | | |
| 3 | Fy b3 | Fy^{b} | M | Y | Q | P | P | S | T | T | R | M | Y | P | | | |
| 4 | Fy b4 | Fy^{b} | M | Y | Q | D | A | G | P | T | E | W | S | Y | | | |
| 5 | Fy b5 | Fy^{b} | M | W | Q | P | A | P | P | S | V | R | G | A | | | |
| 6 | Fy b6 | Fy^{b} | M | F | Q | S | A | G | Y | P | S | S | F | R | | | |
| 7 | Fy b7 | Fy^{b} | M | F | Q | E | H | T | P | A | F | G | G | L | | | |
| 8 | Fy b8 | Fy^{b} | M | F | Q | E | P | L | P | P | F | K | A | S | | | |
| 9 | Fy b9 | Fy^{b} | M | F | Q | P | T | H | W | G | T | R | L | S | | | |
| 10 | Fy b10 | Fy^{b} | M | Q | Q | P | A | G | W | K | Y | L | G | Q | | | |
| 11 | Fy b11 | Fy^{b} | M | V | Q | E | L | P | F | V | L | R | S | K | | | |
| 12 | Fy b12 | Fy^{b} | T | F | Q | P | R | S | W | P | N | I | D | L | | | |
| 13 | Fy b13 | Fy^{b} | T | F | Q | Y | L | D | P | P | P | F | T | P | | | |
| 14 | Fy b14 | Fy^{b} | T | Y | Q | H | N | N | P | D | A | F | R | L | | | |
| 15 | Fy b15 | Fy^{b} | M | F | Q | S | N | T | Y | P | I | W | N | V | | | |
| 16 | Fy b16 | Fy^{b} | F | Q | P | N | P | P | P | S | F | A | A | P | | | |
| 17 | Fy b17 | Fy^{b} | M | Y | Q | G | R | N | D | P | H | L | L | P | | | |
| 18 | Fy b18 | Fy^{b} | M | Y | Q | P | R | D | W | R | S | A | P | P | | | |
| 19 | Fy b19 | Fy^{b} | M | F | N | A | D | P | T | I | P | A | Q | P | | | |
| 20 | Fy b20 | Fy^{b} | H | G | T | N | N | T | D | | | | | | | | |
| 21 | Fy b21 | Fy^{b} | Q | L | D | N | L | T | T | | | | | | | | |
| 22 | Fy b22 | Fy^{b} | H | Y | Y | H | N | T | D | | | | | | | | |
| 23 | Fy b23 | Fy^{b} | H | A | L | P | L | H | A | | | | | | | | |
| 24 | Fy b24 | Fy^{b} | M | F | Q | E | H | P | I | | | | | | | | |
| 25 | Fy b25 | Fy^{b} | M | W | Q | P | S | T | F | | | | | | | | |
| 26 | Fy b26 | Fy^{b} | M | F | Q | P | A | V | Q | | | | | | | | |
| 27 | Fy b27 | Fy^{b} | M | Y | Q | P | L | A | L | | | | | | | | |
| 28 | Fy b28 | Fy^{b} | M | F | Q | P | D | F | L | | | | | | | | |
| 29 | Fy b29 | Fy^{b} | M | F | Q | E | L | V | I | | | | | | | | |
| 30 | Fy b30 | Fy^{b} | M | F | Q | A | N | T | V | | | | | | | | |
| 31 | Fy b31 | Fy^{b} | M | F | Q | P | L | H | R | | | | | | | | |
| 32 | Fy b32 | Fy^{b} | M | F | Q | P | T | D | H | | | | | | | | |
| 33 | Fy b33 | Fy^{b} | M | F | Q | P | L | P | S | | | | | | | | |
| 34 | Fy b34 | Fy^{b} | M | F | Q | P | Q | Y | H | | | | | | | | |
| 35 | Fy b35 | Fy^{b} | M | F | Q | P | P | L | K | | | | | | | | |
| 36 | Fy b36 | Fy^{b} | M | Y | Q | P | P | G | S | | | | | | | | |
| 37 | Fy b37 | Fy^{b} | M | Y | Q | P | R | T | L | | | | | | | | |
| 38 | Fy b38 | Fy^{b} | M | W | Q | P | D | A | R | | | | | | | | |
| 39 | Fy b39 | Fy^{b} | M | Y | Q | D | L | P | Y | | | | | | | | |
| 40 | Fy b40 | Fy^{b} | M | W | Q | P | Q | P | M | P | G | M | V | G | | | |
| 41 | Fy b41 | Fy^{b} | M | Y | Q | P | R | N | W | S | D | A | S | G | | | |
| 42 | Fy b42 | Fy^{b} | T | Y | Q | P | K | S | P | S | N | F | A | N | | | |
| 43 | Fy b43 | Fy^{b} | M | F | Q | P | N | N | P | P | G | I | H | A | | | |
| 44 | Fy b44 | Fy^{b} | M | F | Q | P | Y | H | P | | | | | | | | |
| 45 | Fy b45 | Fy^{b} | M | Y | N | P | P | W | G | | | | | | | | |
| 46 | Fy b46 | Fy^{b} | T | Y | Q | P | L | T | W | | | | | | | | |
| 47 | Fy b47 | Fy^{b} | V | S | H | T | N | N | T | D | L | R | P | P | | | |
| 48 | Fy b48 | Fy^{b} | D | H | P | P | T | L | N | R | P | P | N | V | | | |
| 49 | Fy b49 | Fy^{b} | H | G | V | S | N | T | D | | | | | | | | |
| 50 | Fy b50 | Fy^{b} | M | W | Q | P | R | T | M | | | | | | | | |
| 51 | Fy b51 | Fy^{b} | H | Y | H | S | N | T | D | | | | | | | | |
| 52 | Fy b52 | Fy^{b} | H | Y | A | S | N | T | D | | | | | | | | |
| 53 | Fy b53 | Fy^{b} | M | Y | Q | P | M | T | A | | | | | | | | |
| 54 | Fy b54 | Fy^{b} | M | Y | Q | P | N | S | T | T | Q | L | Y | N | | | |
| 55 | Fy b55 | Fy^{b} | N | F | Q | P | N | D | P | P | A | R | P | S | | | |
| 56 | Fy b56 | Fy^{b} | T | Y | Q | H | M | P | P | P | H | S | P | F | | | |
| 57 | Fy b57 | Fy^{b} | M | Y | Q | E | S | A | P | P | R | Q | V | F | | | |
| 58 | Fy b58 | Fy^{b} | M | W | Q | P | N | S | P | S | V | P | P | P | | | |
| 59 | Fy b59 | Fy^{b} | I | F | N | D | P | W | M | | | | | | | | |
| 60 | Fy b60 | Fy^{b} | M | F | Q | P | L | P | A | | | | | | | | |
| 61 | Fy b61 | Fy^{b} | M | Y | Q | P | T | H | W | | | | | | | | |
| 62 | Fy b62 | Fy^{b} | M | F | Q | P | T | L | V | A | P | L | Q | A | | | |
| 63 | Fy b63 | Fy^{b} | M | F | Q | S | S | P | P | P | L | G | H | A | | | |
| 64 | Fy b64 | Fy^{b} | T | F | Q | P | R | L | F | S | S | W | V | H | | | |
| 65 | Fy b65 | Fy^{b} | M | F | Q | S | R | G | P | N | Q | L | F | P | | | |
| 66 | Fy b66 | Fy^{b} | M | F | Q | P | A | N | P | S | Q | S | T | A | | | |
| 67 | Fy b67 | Fy^{b} | M | W | Q | P | Q | W | T | | | | | | | | |
| 68 | Fy b68 | Fy^{b} | M | F | Q | P | P | R | N | | | | | | | | |
| 69 | Fy b69 | Fy^{b} | M | F | Q | P | R | F | P | | | | | | | | |
| 70 | Fy b70 | Fy^{b} | M | F | Q | P | V | E | L | | | | | | | | |
| 71 | Fy b71 | Fy^{b} | M | Y | Q | P | N | L | M | | | | | | | | |
| 72 | Fy b72 | Fy^{b} | M | Y | Q | P | D | P | P | P | T | K | N | P | | | |
| 73 | Fy b73 | Fy^{b} | M | Y | Q | P | D | P | P | P | T | K | N | V | | | |
| 74 | Fy b74 | Fy^{b} | M | Y | Q | P | D | P | P | T | T | K | N | P | | | |
| 75 | Fy b75 | Fy^{b} | M | Y | Q | P | D | P | P | T | T | K | N | V | | | |
| 76 | Fy b76 | Fy^{b} | M | Y | Q | P | D | N | P | P | T | K | N | P | | | |
| 77 | Fy b77 | Fy^{b} | M | Y | Q | P | D | N | P | P | T | K | N | V | | | |
| 78 | Fy b78 | Fy^{b} | M | Y | Q | P | D | N | P | T | T | K | N | P | | | |
| 79 | Fy b79 | Fy^{b} | M | Y | Q | P | D | N | P | T | T | K | N | V | | | |
| 80 | Fy b80 | Fy^{b} | M | F | Q | P | D | P | P | P | T | K | N | P | | | |
| 81 | Fy b81 | Fy^{b} | M | F | Q | P | D | P | P | P | T | K | N | V | | | |
| 82 | Fy b82 | Fy^{b} | M | F | Q | P | D | P | P | T | T | K | N | P | | | |
| 83 | Fy b83 | Fy^{b} | M | F | Q | P | D | P | P | T | T | K | N | V | | | |
| 84 | Fy b84 | Fy^{b} | M | F | Q | P | D | N | P | P | T | K | N | P | | | |
| 85 | Fy b85 | Fy^{b} | M | F | Q | P | D | N | P | P | T | K | N | V | | | |
| 86 | Fy b86 | Fy^{b} | M | F | Q | P | D | N | P | T | T | K | N | P | | | |
| 87 | Fy b87 | Fy^{b} | M | F | Q | P | D | N | P | T | T | K | N | V | | | |
| 88 | Fy b88 | Fy^{b} | S | P | P | T | P | P | R | F | S | D | D | W | | | |
| 89 | Fy b89 | Fy^{b} | L | P | T | L | H | T | A | H | P | P | V | Q | | | |
| 90 | Fy b90 | Fy^{b} | G | T | Q | T | R | S | S | Y | V | L | T | S | | | |
| 91 | Fy b91 | Fy^{b} | N | P | H | P | M | W | N | P | T | S | Y | L | | | |
| 92 | Fy b92 | Fy^{b} | A | Y | R | A | V | T | L | N | Q | P | L | T | | | |
| 93 | Fy b93 | Fy^{b} | Q | Y | L | P | D | H | R | S | S | Q | P | N | | | |
| 94 | Fy b94 | Fy^{b} | L | P | H | R | T | D | Y | L | Y | T | P | E | | | |
| 95 | Fy b95 | Fy^{b} | H | P | A | V | Q | P | P | L | I | Y | M | F | | | |
| 96 | Fy b96 | Fy^{b} | V | P | T | Y | E | I | I | A | R | G | I | R | | | |
| 97 | Fy b97 | Fy^{b} | S | P | S | D | M | F | I | S | T | Q | R | L | | | |
| 98 | Fy b98 | Fy^{b} | L | L | T | Q | T | T | A | Y | A | P | M | S | | | |
| 99 | Fy b99 | Fy^{b} | M | M | N | S | D | P | K | S | F | L | S | L | | | |
| 100 | Fy | Fy^{b} | M | R | N | D | V | P | W | I | P | W | P | V | | | |
| | b100 | | | | | | | | | | | | | | | | |
| 101 | Fy | Fy^{b} | T | L | P | Y | L | K | M | H | R | N | L | L | | | |
| | b101 | | | | | | | | | | | | | | | | |
| 102 | Fy | Fy^{b} | Q | S | Y | S | P | R | F | | | | | | | | |
| | b102 | | | | | | | | | | | | | | | | |
| 103 | Fy | Fy^{b} | L | K | Q | R | T | L | M | | | | | | | | |
| | b103 | | | | | | | | | | | | | | | | |
| 104 | Fy | Fy^{b} | Q | S | Y | P | Q | A | L | | | | | | | | |
| | b104 | | | | | | | | | | | | | | | | |
| 105 | Fy | Fy^{b} | Q | S | Y | S | P | K | Y | | | | | | | | |
| | b105 | | | | | | | | | | | | | | | | |
| 106 | Fy | Fy^{b} | A | M | Y | Q | P | T | H | | | | | | | | |
| | b106 | | | | | | | | | | | | | | | | |
| 107 | Fy | Fy^{b} | H | W | Y | H | N | T | D | | | | | | | | |
| | b107 | | | | | | | | | | | | | | | | |
| 108 | Fy | Fy^{b} | L | S | Y | S | P | R | Y | | | | | | | | |
| | b108 | | | | | | | | | | | | | | | | |
| 109 | Fy | Fy^{b} | E | S | Y | S | P | R | H | | | | | | | | |
| | b109 | | | | | | | | | | | | | | | | |
| 110 | Fy | Fy^{b} | Q | S | Y | P | S | V | Y | | | | | | | | |
| | b110 | | | | | | | | | | | | | | | | |
| 111 | Fy | Fy^{b} | D | S | Y | S | P | K | F | | | | | | | | |
| | b111 | | | | | | | | | | | | | | | | |
| 112 | Fy | Fy^{b} | Q | S | Y | P | A | K | F | | | | | | | | |
| | b112 | | | | | | | | | | | | | | | | |
| 113 | Fy | Fy^{b} | R | S | A | S | A | L | W | | | | | | | | |
| | b113 | | | | | | | | | | | | | | | | |
| 114 | Fy | Fy^{b} | E | S | Y | S | P | R | L | | | | | | | | |
| | b114 | | | | | | | | | | | | | | | | |
| 115 | Fy | Fy^{b} | P | I | F | T | K | L | H | | | | | | | | |
| | b115 | | | | | | | | | | | | | | | | |
| 116 | Fy | Fy^{b} | Q | S | Y | P | Y | R | G | | | | | | | | |
| | b116 | | | | | | | | | | | | | | | | |

Biopanning with the anti-Fy^{a} monoclonal, LM487, identified a total of 37 unique peptide sequences (see Table 3/Fy^{a} peptides Fya1-37). A small number of the “Fya” phage-peptides, contained sequence identical to the Fy^{a} polymorphism, present within the original 14-mer immunisation peptide (PDGDYGANLEAAAP; CPep118), thus validating the use of phage display as an approach to identifying blood group antigen mimics. Sequence analysis of the amino acid sequences of these “Fya” peptide mimotopes also identified 2 putative consensus sequences:

| | |
|---|---|
| Consensus I: | YNYQSYPNPFPV |
| Consensus II: | GI(A/S) (E/D) (D/G)DYGALSW |

However, in contrast to the “Fyb” results, many of these “Fya” peptide mimotope sequences did not conform to either consensus sequence identified above.

TABLE 3
Fya peptides

| SEQ | | | | | | | | | | | | | | | | | |
|---|---|---|---|---|---|---|---|---|---|---|---|---|---|---|---|---|---|
| ID | | Panning | | | | | | | | | | | | | | | |
| NO: | Pep ID | Antibody | 1 | 2 | 3 | 4 | 5 | 6 | 7 | 8 | 9 | 10 | 11 | 12 | 13 | 14 | 15 |
| 117 | Fy a1 | Fy^{a} | W | Q | S | Y | P | N | P | | | | | | | | |
| 118 | Fy a2 | Fy^{a} | T | N | L | R | L | P | A | | | | | | | | |
| 119 | Fy a3 | Fy^{a} | Y | Q | S | Y | P | P | P | | | | | | | | |
| 120 | Fy a4 | Fy^{a} | Y | Q | S | Y | P | M | R | | | | | | | | |
| 121 | Fy a5 | Fy^{a} | M | Y | P | D | W | Q | Q | | | | | | | | |
| 122 | Fy a6 | Fy^{a} | L | E | R | D | P | P | V | | | | | | | | |
| 123 | Fy a7 | Fy^{a} | Y | Q | S | Y | P | N | W | | | | | | | | |
| 124 | Fy a8 | Fy^{a} | L | V | P | P | D | G | Y | | | | | | | | |
| 125 | Fy a9 | Fy^{a} | A | P | F | W | Q | W | M | | | | | | | | |
| 126 | Fy a10 | Fy^{a} | F | S | P | P | N | W | Y | | | | | | | | |
| 127 | Fy a11 | Fy^{a} | F | A | P | W | Y | Q | Q | R | | | | | | | |
| 128 | Fy a12 | Fy^{a} | Q | S | Y | P | N | T | F | | | | | | | | |
| 129 | Fy a13 | Fy^{a} | D | W | L | F | K | M | S | | | | | | | | |
| 130 | Fy a14 | Fy^{a} | G | D | W | L | H | W | | | | | | | | | |
| 131 | Fy a15 | Fy^{a} | S | D | G | D | Y | G | A | | | | | | | | |
| 132 | Fy a16 | Fy^{a} | G | P | S | W | Q | S | T | | | | | | | | |
| 133 | Fy a17 | Fy^{a} | V | P | Y | P | N | Q | M | C | | | | | | | |
| 134 | Fy a18 | Fy^{a} | P | S | P | G | Q | I | | | | | | | | | |
| 135 | Fy a19 | Fy^{a} | F | E | P | P | N | W | D | S | G | P | R | P | | | |
| 136 | Fy a20 | Fy^{a} | G | I | A | E | D | D | Y | G | A | L | S | W | | | |
| 137 | Fy a21 | Fy^{a} | Y | N | Q | Y | Q | S | Y | P | P | S | L | Q | | | |
| 138 | Fy a22 | Fy^{a} | Y | Q | S | Y | P | S | R | P | P | V | R | L | | | |
| 139 | Fy a23 | Fy^{a} | A | L | A | P | E | E | D | E | V | Y | Y | V | | | |
| 140 | Fy a24 | Fy^{a} | V | L | L | P | E | S | D | E | S | H | R | A | | | |
| 141 | Fy a25 | Fy^{a} | I | P | N | W | Q | S | C | | | | | | | | |
| 142 | Fy a26 | Fy^{a} | S | G | V | A | F | C | P | P | W | W | C | D | G | P | L |
| 143 | Fy a27 | Fy^{a} | W | P | R | H | V | P | L | F | G | L | D | G | Y | V | T |
| 144 | Fy a28 | Fy^{a} | A | R | E | Y | G | T | R | F | S | L | I | G | G | Y | R |
| 145 | Fy a29 | Fy^{a} | A | S | R | R | L | L | P | S | D | V | R | L | P | S | S |
| 146 | Fy a30 | Fy^{a} | L | W | D | P | P | P | F | G | L | S | R | I | F | F | G |
| 147 | Fy a31 | Fy^{a} | D | A | R | P | L | A | W | Y | E | E | P | S | F | W | M |
| 148 | Fy a32 | Fy^{a} | S | G | Y | A | R | P | F | Y | Q | S | Y | P | A | A | S |
| 149 | Fy a33 | Fy^{a} | V | N | S | T | K | W | P | G | M | P | S | F | | | |
| 150 | Fy a34 | Fy^{a} | V | S | P | P | E | W | Y | P | L | A | A | D | | | |
| 151 | Fy a35 | Fy^{a} | T | G | P | K | L | H | C | P | P | A | V | C | | | |
| 152 | Fy a36 | Fy^{a} | F | K | N | P | S | Q | S | Y | P | P | E | P | | | |
| 153 | Fy a37 | Fy^{a} | F | T | M | E | R | D | P | P | I | A | R | V | | | |

The data shows that phage-peptides were identified that mimicked the Duffy antigenic epitopes. The anti-Fy^{a} antibody bound phage-peptides (Peptides Fya15 & Fya20) that contained sequences identical to the Fy^{a} polymorphism and the anti-Fy^{b} antibody selected peptide mimotopes, confirming the use of phage display as a valid means of identifying blood group antigen mimics.

### Example 2

### Identification of Phage-Peptides which Mimic the Complex RhD Antigenic Epitopes

Phage-peptides that mimic RhD antigenic epitopes were identified with 3 monoclonal anti-Ds (T10, T22 & T27). Biopanning of the 4 phage-peptide libraries with this limited number of monoclonal antibodies selected 80 RhD peptide mimotopes (see Table 4/Peptides RhD 1-80). Additionally, biopanning with a polyclonal anti-RhD preparation identified a further 25 RhD peptide mimotopes (see Table 4/peptides RhD81-105). Peptide RhD52 was selected with both T10 and the polyclonal anti-RhD preparation.

TABLE 4
RhD peptides

| SEQ | | | | | | | | | | | | | | | | | |
|---|---|---|---|---|---|---|---|---|---|---|---|---|---|---|---|---|---|
| ID | | Panning | | | | | | | | | | | | | | | |
| NO: | Pep ID | Antibody | 1 | 2 | 3 | 4 | 5 | 6 | 7 | 8 | 9 | 10 | 11 | 12 | 13 | 14 | 15 |
| 154 | RhD 1 | RhD T27 | G | L | F | K | I | Q | P | | | | | | | | |
| 155 | RhD 2 | RhD T27 | L | G | H | H | N | P | H | | | | | | | | |
| 156 | RhD 3 | RhD T27 | N | L | L | P | A | K | L | | | | | | | | |
| 157 | RhD 4 | RhD T27 | H | T | A | L | S | T | S | | | | | | | | |
| 158 | RhD 5 | RhD T27 | T | P | G | S | G | Q | F | | | | | | | | |
| 159 | RhD 6 | RhD T27 | F | S | P | N | N | S | E | T | T | N | Y | T | | | |
| 160 | RhD 7 | RhD T27 | T | T | V | P | D | T | W | V | L | F | P | R | | | |
| 161 | RhD 8 | RhD T27 | S | N | V | P | L | H | W | I | L | S | P | R | | | |
| 162 | RhD 9 | RhD T27 | W | H | F | E | W | W | R | A | T | P | S | G | | | |
| 163 | RhD 10 | RhD T27 | N | Y | P | A | V | V | S | N | S | L | L | A | | | |
| 164 | RhD 11 | RhD T27 | D | V | Y | D | T | R | P | Y | H | G | F | M | | | |
| 165 | RhD 12 | RhD T27 | H | Q | N | P | W | L | L | W | P | R | G | F | | | |
| 166 | RhD 13 | RhD T27 | V | I | D | W | L | L | C | P | R | G | F | S | A | C | M |
| 167 | RhD 14 | RhD T27 | D | R | R | I | F | W | W | S | L | R | S | A | P | G | A |
| 168 | RhD 15 | RhD T27 | L | H | A | W | H | R | N | T | I | G | W | W | I | G | F |
| 169 | RhD 16 | RhD T22 | W | G | L | W | F | S | N | | | | | | | | |
| 170 | RhD 17 | RhD T22 | W | G | I | W | W | N | N | | | | | | | | |
| 171 | RhD 18 | RhD T22 | W | G | L | W | S | T | P | | | | | | | | |
| 172 | RhD 19 | RhD T22 | W | V | H | L | Q | S | P | | | | | | | | |
| 173 | RhD 20 | RhD T22 | W | G | L | W | W | H | T | | | | | | | | |
| 174 | RhD 21 | RhD T22 | W | G | L | W | W | T | G | | | | | | | | |
| 175 | RhD 22 | RhD T22 | L | L | G | L | T | E | T | | | | | | | | |
| 176 | RhD 23 | RhD T22 | D | S | R | W | L | L | P | | | | | | | | |
| 177 | RhD 24 | RhD T22 | F | H | W | W | P | R | T | Q | D | P | H | R | | | |
| 178 | RhD 25 | RhD T22 | F | H | W | S | W | Y | T | P | S | R | P | S | | | |
| 179 | RhD 26 | RhD T22 | H | S | S | W | W | L | A | L | A | K | P | T | | | |
| 180 | RhD 27 | RhD T22 | W | H | W | Y | P | R | F | S | P | P | S | H | | | |
| 181 | RhD 28 | RhD T22 | N | D | Y | S | D | S | N | Q | V | P | A | S | | | |
| 182 | RhD 29 | RhD T22 | F | H | W | P | R | S | W | V | T | W | Q | S | | | |
| 183 | RhD 30 | RhD T22 | H | L | S | S | R | H | L | F | V | P | L | S | | | |
| 184 | RhD 31 | RhD T22 | T | I | T | D | C | Y | P | I | C | V | S | P | | | |
| 185 | RhD 32 | RhD T22 | W | P | C | H | P | I | C | L | S | P | R | G | | | |
| 186 | RhD 33 | RhD T22 | A | M | D | C | F | P | I | C | L | W | N | P | | | |
| 187 | RhD 34 | RhD T22 | W | N | C | F | P | I | C | H | A | S | G | L | | | |
| 188 | RhD 35 | RhD T22 | V | Y | A | L | G | C | W | P | I | C | H | K | | | |
| 189 | RhD 36 | RhD T22 | H | H | V | F | T | P | N | C | Y | P | I | C | | | |
| 190 | Rh0 37 | RhD T22 | W | H | W | S | S | L | S | W | P | A | L | P | | | |
| 191 | RhD 38 | RhD T22 | G | N | W | L | F | N | S | C | Y | P | L | C | F | P | L |
| 192 | RhD 39 | RhD T22 | A | F | L | G | H | S | H | W | F | P | S | V | A | S | R |
| 193 | RhD 40 | RhD T22 | Q | L | L | C | F | P | I | C | R | P | E | P | P | V | S |
| 194 | RhD 41 | RhD T10 | W | Y | T | K | A | P | Y | | | | | | | | |
| 195 | RhD 42 | RhD T10 | W | Y | H | K | A | P | Y | | | | | | | | |
| 196 | Rh0 43 | RhD T10 | Y | Y | Q | R | A | P | Y | | | | | | | | |
| 197 | RhD 44 | RhD T10 | H | W | K | H | P | W | G | A | W | D | T | L | | | |
| 198 | RhD 45 | RhD T10 | W | H | W | Q | W | T | P | W | S | I | Q | P | | | |
| 199 | RhD 46 | RhD T10 | W | H | K | N | W | W | P | P | S | T | P | N | | | |
| 200 | RhD 47 | RhD T10 | S | M | S | S | M | L | L | A | A | Q | T | V | | | |
| 201 | RhD 48 | RhD T10 | Q | S | H | Y | R | H | I | S | P | A | Q | V | | | |
| 202 | RhD 49 | RhD T10 | S | M | S | Q | P | K | S | Q | V | N | A | H | | | |
| 203 | RhD 50 | RhD T10 | W | H | W | T | F | Y | T | P | L | E | S | T | | | |
| 204 | RhD 51 | RhD T10 | E | S | L | S | T | D | T | Y | A | I | L | L | | | |
| 205 | RhD 52 | RhD T10 | H | S | S | W | Y | I | Q | H | F | P | P | L | | | |
| 206 | RhD 53 | RhD T10 | S | T | Y | L | N | G | P | T | G | V | D | L | | | |
| 207 | RhD 54 | RhD T10 | Q | H | K | T | S | I | T | G | H | L | E | P | | | |
| 208 | RhD 55 | RhD T10 | F | H | R | W | P | T | W | P | L | P | S | P | | | |
| 209 | RhD 56 | RhD T10 | V | P | P | W | V | S | V | R | T | G | P | G | | | |
| 210 | RhD 57 | RhD T10 | T | L | V | Y | Q | P | P | W | Y | R | I | A | | | |
| 211 | RhD 58 | RhD T10 | F | H | Q | R | L | W | W | P | T | H | T | P | | | |
| 212 | RhD 59 | RhD T10 | W | H | W | R | L | Y | S | A | N | T | P | | | | |
| 213 | RhD 60 | RhD T10 | H | A | A | F | E | P | R | G | D | V | R | H | T | L | L |
| 214 | RhD 61 | RhD T10 | S | I | W | D | L | P | L | Q | Y | R | G | F | G | T | S |
| 215 | RhD 62 | RhD T10 | L | W | R | L | R | G | G | S | F | P | V | I | S | H | G |
| 216 | RhD 63 | RhD T10 | R | N | A | L | H | S | L | R | T | L | S | S | S | W | V |
| 217 | RhD 64 | RhD T10 | F | H | R | H | W | W | P | P | T | L | S | T | | | |
| 218 | RhD 65 | RhD T10 | R | P | H | L | L | D | W | E | L | N | P | V | | | |
| 219 | RhD 66 | RhD T10 | F | H | W | R | W | S | T | F | P | E | Y | P | | | |
| 220 | RhD 67 | RhD T10 | V | W | A | V | S | L | P | W | Y | R | Y | P | | | |
| 221 | RhD 68 | RhD T10 | L | D | T | Y | W | Y | R | E | H | F | R | R | | | |
| 222 | RhD 69 | RhD T10 | V | H | W | R | W | W | D | Q | R | V | P | M | | | |
| 223 | RhD 70 | RhD T10 | L | P | W | Y | Q | L | T | | | | | | | | |
| 224 | RhD 71 | RhD T10 | V | P | W | F | R | A | P | | | | | | | | |
| 225 | RhD 72 | RhD T10 | W | H | P | P | Q | P | S | | | | | | | | |
| 226 | RhD 73 | RhD T10 | F | H | E | N | W | P | S | | | | | | | | |
| 227 | RhD 74 | RhD T10 | F | W | W | Q | V | P | A | | | | | | | | |
| 228 | RhD 75 | RhD T10 | T | Q | W | Y | Q | I | A | | | | | | | | |
| 229 | RhD 76 | RhD T10 | L | P | W | F | Q | L | P | | | | | | | | |
| 230 | RhD 77 | RhD T10 | T | P | L | S | K | S | T | | | | | | | | |
| 231 | RhD 78 | RhD T10 | L | P | W | Y | A | T | P | | | | | | | | |
| 232 | RhD 79 | RhD T10 | L | P | W | Y | R | H | | | | | | | | | |
| 233 | RhD 80 | RhD T10 | I | P | W | Y | K | I | T | | | | | | | | |
| 234 | RhD 81 | RhD | F | H | S | T | W | P | W | R | E | A | E | G | | | |
| | | polyclonal | | | | | | | | | | | | | | | |
| 235 | RhD 82 | RhD | F | H | A | N | W | P | Q | S | A | R | D | V | | | |
| | | polyclonal | | | | | | | | | | | | | | | |
| 236 | RhD 83 | RhD | F | H | S | D | W | P | G | Q | T | F | T | W | | | |
| | | polyclonal | | | | | | | | | | | | | | | |
| 237 | RhD 84 | RhD | F | H | E | N | W | S | T | R | P | T | T | R | | | |
| | | polyclonal | | | | | | | | | | | | | | | |
| 238 | RhD 85 | RhD | F | H | S | V | Y | P | W | R | E | A | E | G | | | |
| | | polyclonal | | | | | | | | | | | | | | | |
| 239 | RhD 86 | RhD | F | H | S | N | W | P | S | A | Y | T | A | R | | | |
| | | polyclonal | | | | | | | | | | | | | | | |
| 240 | RhD 87 | RhD | F | H | S | N | W | P | S | L | I | R | A | R | | | |
| | | polyclonal | | | | | | | | | | | | | | | |
| 241 | RhD 88 | RhD | A | G | Y | Q | I | G | M | P | N | P | L | L | | | |
| | | polyclonal | | | | | | | | | | | | | | | |
| 242 | RhD 89 | RhD | F | H | W | R | Y | P | L | P | L | P | G | Q | | | |
| | | polyclonal | | | | | | | | | | | | | | | |
| 243 | RhD 90 | RhD | S | P | T | S | F | R | Q | V | F | G | F | Y | | | |
| | | polyclonal | | | | | | | | | | | | | | | |
| 244 | RhD 91 | RhD | A | L | P | E | L | S | S | L | P | E | S | A | R | | |
| | | polyclonal | | | | | | | | | | | | | | | |
| 245 | RhD 92 | RhD | L | H | W | W | P | T | Y | G | N | N | G | M | | | |
| | | polyclonal | | | | | | | | | | | | | | | |
| 246 | RhD 93 | RhD | F | H | R | P | Y | Y | W | P | P | T | P | L | | | |
| | | polyclonal | | | | | | | | | | | | | | | |
| 247 | RhD 94 | RhD | F | H | W | R | L | P | Y | P | L | P | S | S | | | |
| | | polyclonal | | | | | | | | | | | | | | | |
| 248 | RhD 95 | RhD | I | H | W | W | V | K | S | P | P | P | G | S | | | |
| | | polyclonal | | | | | | | | | | | | | | | |
| 249 | RhD 96 | RhD | S | H | W | W | T | S | I | L | A | T | P | S | | | |
| | | polyclonal | | | | | | | | | | | | | | | |
| 250 | RhD 97 | RhD | F | H | W | H | L | Q | P | Q | L | W | S | Y | | | |
| | | polyclonal | | | | | | | | | | | | | | | |
| 251 | RhD 98 | RhD | L | H | R | E | W | I | Y | P | Y | L | I | S | | | |
| | | polyclonal | | | | | | | | | | | | | | | |
| 252 | RhD 99 | RhD | G | Q | K | T | H | N | P | F | H | L | H | P | | | |
| | | polyclonal | | | | | | | | | | | | | | | |
| 253 | RhD 100 | RhD | A | T | W | S | H | H | L | S | S | A | G | L | | | |
| | | polyclonal | | | | | | | | | | | | | | | |
| 254 | RhD 101 | RhD | F | H | R | H | Y | Y | P | W | A | L | I | Q | | | |
| | | polyclonal | | | | | | | | | | | | | | | |
| 255 | RhD 102 | RhD | H | S | L | K | H | T | Q | M | S | Y | S | S | | | |
| | | polyclonal | | | | | | | | | | | | | | | |
| 256 | RhD 103 | RhD | S | V | S | V | G | M | K | P | S | P | R | P | | | |
| | | polyclonal | | | | | | | | | | | | | | | |
| 257 | RhD 104 | RhD | W | P | H | Q | V | H | K | H | I | Y | R | Q | | | |
| | | polyclonal | | | | | | | | | | | | | | | |
| 258 | RhD 105 | RhD | A | P | P | Y | P | G | P | L | P | L | S | L | | | |
| | | polyclonal | | | | | | | | | | | | | | | |

### Example 3

Identification of Phage-Peptides which Mimic RhEe Antigenic Epitopes

Biopanning was undertaken with 3 anti-RhE monoclonal antibodies (1×IgG, 2×IgM; see Table 1) and resulted in the identification of multiple copies of many sequences from each of the 4 phage-peptide libraries. Sequence similarities were also evident between the selected phage-peptides from the different libraries. Peptides RhE18 and RhE24 were selected with antibodies E0002 and E0003 and Peptide RhE19 was selected with antibodies E0001 and E0002 These results indicate that, regardless of class, antibodies raised against the same epitope will identify some phage with the identical peptide sequence. In total, 36 unique RhE peptide mimotopes were identified (see Table 5; Peptides RhE1-36). Biopanning with 2 anti-Rhe monoclonal antibodies (2×IgM; see Table 1) identified 17 unique Rhe peptide mimotopes (see Table 5; Peptides Rhe1-17).

TABLE 5
RhE/e

| SEQ | | | | | | | | | | | | | | | | | |
|---|---|---|---|---|---|---|---|---|---|---|---|---|---|---|---|---|---|
| ID | | Panning | | | | | | | | | | | | | | | |
| NO: | Pep ID | Antibody | 1 | 2 | 3 | 4 | 5 | 6 | 7 | 8 | 9 | 10 | 11 | 12 | 13 | 14 | 15 |
| 256 | RhE1 | RhE | A | A | P | P | Y | V | F | C | S | L | S | P | R | | |
| 260 | RhE2 | RhE | T | V | D | L | S | P | A | F | L | F | F | G | R | L | A |
| 261 | RhE3 | RhE | S | L | A | P | Y | S | L | R | I | L | R | V | G | S | A |
| 262 | RhE4 | RhE | R | N | V | L | P | I | F | N | D | V | Y | W | I | A | L |
| 263 | RhE5 | RhE | R | N | V | P | P | I | F | N | D | V | Y | W | I | A | F |
| 264 | RhE6 | RhE | I | N | N | T | F | T | W | | | | | | | | |
| 265 | RhE7 | RhE | Y | E | L | N | L | M | T | | | | | | | | |
| 266 | RhE8 | RhE | W | G | I | T | V | E | T | A | Y | G | T | A | | | |
| 267 | RhE9 | RhE | N | Q | F | L | L | W | E | T | R | S | M | R | | | |
| 268 | RhE10 | RhE | N | V | S | L | T | N | L | T | Y | K | P | R | | | |
| 269 | RhE11 | RhE | Y | T | P | P | D | W | S | W | W | P | A | P | | | |
| 270 | RhE12 | RhE | I | K | N | T | S | L | Q | Q | L | V | T | A | | | |
| 271 | RhE13 | RhE | E | W | L | A | Y | D | G | I | R | A | Y | S | | | |
| 272 | RhE14 | RhE | H | A | K | V | Q | V | S | S | P | F | P | P | | | |
| 273 | RhE15 | RhE | L | S | S | Q | F | K | Q | | | | | | | | |
| 274 | RhE16 | RhE | G | T | F | K | W | Y | Q | | | | | | | | |
| 275 | RhE17 | RhE | T | K | M | D | Q | S | T | | | | | | | | |
| 276 | RhE18 | RhE | I | P | E | E | A | L | R | A | R | F | K | T | | | |
| 277 | RhE19 | RhE | S | F | Q | D | A | L | L | S | R | W | Y | S | | | |
| 278 | RhE20 | RhE | S | N | L | R | S | W | L | F | P | F | D | R | V | G | N |
| 279 | RhE21 | RhE | P | G | P | M | F | G | G | S | Y | I | P | S | L | H | H |
| 280 | RhE22 | RhE | Y | P | Q | G | L | W | R | | | | | | | | |
| 281 | RhE23 | RhE | Y | P | Q | G | E | W | R | | | | | | | | |
| 282 | RhE24 | RhE | G | P | S | Y | Y | A | L | I | T | R | Y | L | G | A | A |
| 283 | RhE25 | RhE | G | L | S | Y | Y | A | L | I | T | R | Y | L | G | A | A |
| 284 | RhE26 | RhE | W | P | P | I | S | R | H | | | | | | | | |
| 285 | RhE27 | RhE | A | H | S | W | L | P | G | A | G | L | L | M | | | |
| 286 | RhE28 | RhE | S | L | T | H | S | P | R | T | P | I | L | A | | | |
| 287 | RhE29 | RhE | F | P | N | L | R | E | R | H | E | P | L | F | | | |
| 288 | RhE30 | RhE | G | H | S | Y | H | A | L | I | T | R | Y | L | G | A | A |
| 289 | RhE31 | RhE | W | A | S | Y | Y | A | L | I | T | R | Y | L | G | A | A |
| 290 | RhE32 | RhE | D | F | A | Q | A | L | F | L | R | Y | V | V | S | G | L |
| 291 | RhE33 | RhE | H | R | W | M | P | H | V | F | A | V | R | Q | G | A | L |
| 292 | RhE34 | RhE | W | A | S | F | Y | A | S | S | Y | R | D | S | R | L | L |
| 293 | RhE35 | RhE | R | L | P | A | T | I | R | A | L | L | G | R | D | V | R |
| 294 | RhE36 | RhE | R | L | P | A | T | I | R | A | L | L | G | R | D | V | W |
| 295 | Rhe1 | Rhe | V | P | R | H | N | P | I | | | | | | | | |
| 296 | Rhe2 | Rhe | P | K | A | F | Q | Y | G | G | R | A | V | G | G | L | W |
| 297 | Rhe3 | Rhe | D | S | G | A | L | F | N | H | I | F | M | P | G | P | F |
| 298 | Rhe4 | Rhe | L | H | S | S | H | L | P | P | D | D | R | R | W | G | L |
| 299 | Rhe5 | Rhe | P | R | Q | F | P | L | R | D | L | Y | T | F | R | Y | W |
| 300 | Rhe6 | Rhe | G | A | A | N | L | Y | V | S | S | F | L | I | P | L | H |
| 301 | Rhe7 | Rhe | R | N | V | P | P | I | F | N | D | V | Y | W | I | A | L |
| 302 | Rhe8 | Rhe | Q | P | R | G | V | T | V | H | G | D | A | W | R | V | A |
| 303 | Rhe9 | Rhe | G | L | D | L | L | G | D | V | R | I | P | V | V | R | R |
| 304 | Rhe10 | Rhe | A | Y | W | D | L | Y | G | V | G | F | A | F | S | A | P |
| 305 | Rhe11 | Rhe | I | W | T | I | T | G | S | T | K | Q | A | F | D | R | S |
| 306 | Rhe12 | Rhe | E | D | W | F | S | A | S | I | R | R | V | P | T | F | A |
| 307 | Rhe13 | Rhe | A | V | K | L | R | P | S | S | C | W | L | K | S | T | C |
| 308 | Rhe14 | Rhe | R | F | D | G | I | D | L | R | V | S | F | V | S | R | P |
| 309 | Rhe15 | Rhe | A | S | L | H | P | V | P | K | T | W | F | S | L | L | S |
| 310 | Rhe16 | Rhe | L | A | P | P | P | S | P | | | | | | | | |
| 311 | Rhe17 | Rhe | A | V | T | F | N | S | Y | F | G | F | S | T | T | S | V |

### Example 4

### Specific Binding of Synthetic Peptides to the Original Duffy Monoclonal Antibodies

The relevance of the phage-peptides selected by biopanning was tested in immunological studies. Initially, 20 “Fy^{b}” phage (Peptides Fyb1-13, Fyb 20-21, Fyb 24-28; see Table 2 for sequence details) were selected for investigation by both phage ELISA and SPOTs analysis, to confirm that synthetic peptides could bind specifically the original monoclonal antibodies.

The phage ELISA results confirmed the binding of the anti-Fy^{b} monoclonal, LM447. A 10 μg/ml stock of this monoclonal antibody was prepared in ELISA coating buffer and 150 μl aliquots were added to wells of an Immulon 4 ELISA plate, and then incubated overnight at 4° C. Unbound antibody was discarded and the wells were blocked with 350 μl of blocking buffer for 1 hour at 4° C. The wells were washed three times with 300 μl TBS/0.5% Tween 20 and 100 μl of selected phage culture supernatants were added to appropriate wells for 1 hour at room temperature. Unbound phage were removed and the wells washed six times with 300 μl TBS/0.5% Tween 20. A 1:5000 dilution of horseradish peroxidase (HRP) conjugated anti-M13, secondary antibody was prepared in blocking buffer and 100 μl aliquots added to each well. Following incubation for 1 hour at room temperature the wells were washed six times with 300 μl TBS/0.5% Tween 20. To develop the reactions, 200 μl aliquots of o-phenylenediamine dihydrochloride (OPD) substrate (Sigma) was added to each well. The absorbance at 450 nm was measured following incubation at room temperature for 1 hour. The absorbance values at 450 nm, confirmed the binding of 14 (Peptides Fyb1, Fyb2, Fyb4-5, Fyb7-13, Fyb25, 27 & 28) of the 20 phage assayed (see FIG. 1).

The 20 Fy^{b} peptide mimotopes were synthesised in duplicate, by SPOTs. Binding experiments using the anti-Fy^{b} antibody (LM447) showed that the antibody successfully bound 2 of the 20 peptide sequences (Peptides Fyb12 & Fyb13) tested (FIG. 2). Binding was also observed in Spot 21 with the Peptide CPep75 (the positive control for the assay). Despite Peptides Fyb1, Fyb7, Fyb9 and Fybll producing phage ELISA signals equally as strong as Peptides Fyb12 and Fyb13, these 4 peptides failed to react with the anti-Fy^{b} antibody (LM447) when synthesised as SPOTs.

Phage ELISA analysis of 19 “Fy^{a}” phage-peptide clones (Peptides Fya1-18 & Fya25; see Table 3 for sequence details) confirmed the binding specificity of the LM487 antibody for the Fy^{a} phage-peptides. FIG. 3 shows that only 3 of 19 (Peptides Fya2, Fya14 & Fya18) failed to bind the antibody. These 19 peptides were amongst 37 (Peptides Fya1-37) synthesised as SPOTs and a strong positive signal was only observed with Peptide Fya15 (Spot 15), following hybridisation of the membrane with the anti-Fy^{a} antibody (FIG. 4).

These results mirrored the observations obtained for the Fy^{b} phage-peptides when tested in parallel by both phage ELISA and SPOTs. A positive phage ELISA signal did not automatically guarantee a positive signal when the corresponding peptide mimotope was synthesised and tested by SPOTs hybridisation. Moreover, sequence analysis identified no obvious sequence similarities amongst either positive or negative peptides.

The results from both the Fy^{a} and Fy^{b} phage ELISA and SPOTs assays suggested that the mode of presentation of the peptide is important in antibody binding. Peptides that form part of a fusion protein in the phage coat may adopt a different conformation when synthesised on a membrane by SPOTs. Without the surrounding protein, antibody recognition may be subsequently affected. Therefore, rather than simply using ELISA to select phage-peptide clones for analysis by SPOTs, all phage-peptides (Fy^{b}, Fy^{a}, RhD and RhEe) selected by biopanning were characterised by DNA sequence analysis, prior to SPOTs analysis with the monoclonal antibody originally, used in their selection, in order to ensure no potentially diagnostic peptide was overlooked.

Reciprocal Hybridisation to Identify Cross-Reactive Peptides

A series of 44 peptides was synthesised in duplicate (FIG. 5). Spots 1-37 were Fya peptide mimotopes (Fya 1-37), Spots 38-40 were repeats of Peptides Fya17, Fya25 and Fya35, respectively and Spots 41-44 were Control peptides (Spot 41 was the immunisation peptide [Cpep75] used to generate the anti-Fy^{b} antibody; Spot 42 an irrelevant 12-mer [Cpep76]; Spot 43 the immunisation peptide [CPep118] used to generate the anti-Fy^{a} antibody and Spot 44 an Fyb peptide mimotope [Fyb1]). Hybridisation of the membranes, in parallel, with the anti-Fy^{a} and anti-Fy^{b} monoclonal antibodies, confirmed the Fy^{a}-specificity of a number of the peptides (Peptide spots 15, 20, and 43) but also identified peptides capable of binding the anti-Fy^{b} antibody (Spots 36 and 41) and a further peptide displaying cross-reactivity with both antibodies (Spot 3). The signals observed with Spots 43 and 41 were not unexpected as these 2 peptides were included as positive controls for the anti-Fy^{a} and anti-Fy^{b} monoclonal antibodies, respectively.

Generation of Consensus Sequence-Derived Synthetic Fyb Peptide Mimotopes by Amino Acid Substitution

Sequence analysis of the 100 unique “Fyb” peptide mimotopes (Fyb1-71 & Fyb88-116) had identified 2 consensus sequences. Consensus 1: M(F/Y)QPD(N/P)(P/L)(T/P)T(K/L)(N/Q)(P/V/A/S) contains a series of positions (amino acid 2, 6, 7, 8, 10, 11 & 12) which have a limited number of residues occurring with equal frequency. A series of 16 peptide mimotopes (Peptides Fyb72-87; see Table 2) were synthesised by SPOTs, with amino acid substitutions at positions 2, 6, 8 and 12. On testing, 2 of these consensus sequence-derived peptide mimotopes (Peptide Fyb84; Spot 13 and Peptide Fyb85; Spot 14) proved capable of binding the anti-Fy^{b} antibody LM447 (see FIG. 6). Analysis of these 2 synthetic, peptide mimotope sequences identified a single amino acid difference at position 12. The strength of signal observed for these 2 sequences was however dramatically lower than that achieved with Peptide CPep75 (Spot 17), the positive control used for this assay. This result shows that peptide mimotopes may also be artificially generated through amino acid substitution experiments and not simply through biopanning.

### Example 5

### Specific Binding of Antibodies to Synthetic Rh Peptides Determined by SPOTs

The RhD, RhE and Rhe peptide mimotopes (see Tables 4 & 5) were synthesised by SPOTs and hybridisation of the membranes was undertaken with the appropriate antibodies (Table 1). FIGS. 7-10 show examples of peptide mimotopes reacting specifically with the antibody originally used in their selection.

FIG. 7 shows the results following hybridisation of a subset of the anti-RhD antibody-selected peptide mimotopes with the monoclonal antibody T10. 40 peptides (RhD41-RhD80) were synthesised and positive signals were observed in 11 spots (Spots 1-3, 8, 17, 27, 28, 31, 37, 39 & 40; see Table for peptide sequences).

A further 28 RhD peptide mimotopes were synthesised by SPOTs. Peptide mimotopes RhD81-105 (Spots 1-25) were originally selected with the polyclonal anti-RhD preparation and Peptides RhD68, RhD71 and RhD79 (Spots 26-28) were identified through biopanning with the anti-RhD antibody T10. The peptides CPep75 (Spot 29) and CPep76 (Spot 30) were included in the assay as negative controls. FIG. 8 identifies a series of 11 peptides recognised by the polyclonal anti-RhD (Spots 3, 5, 6, 12, 14, 16, 24, 26-28 & 30; see Table for peptide sequences). This series of peptides includes 3 peptides (Spots 26-28) originally selected with T10. This result strongly suggested that peptides identified with individual monoclonal antibodies (eg T10) mimic epitopes of the antigen to which the polyclonal antibody was raised.

FIG. 9 shows the results following hybridisation of the 36 RhE peptide mimotopes with the anti-RhE monoclonal antibody E0002. The peptides CPep75 (Spot 37) and CPep76 (Spot 38) were included in the assay as negative controls. Specific binding of the antibody was achieved with 4 spots (Spot 18: Peptide mimotope RhE18; Spot 19: RhE19; Spot 24: RhE24 & Spot 25: RhE25).

FIG. 10 shows the results following hybridisation of the 16 Rhe peptide mimotopes with the anti-Rhe monoclonal antibody e0002. The peptides CPep75 (Spot 17) and CPep76 (Spot 18) were included in the assay as negative controls. Strong positive signals were observed with 2 spots (Spots 10 & 13; see Table for peptide sequences). A further 3 weakly, positive spots were also noted (Spots 8, 11 & 16) however these signals were only as strong as that achieved with the control peptide CPep 76 (Spot 18) which was included in the assay as a negative control.

Overall, the results achieved with the Rh peptide mimotopes were comparable to those obtained with the Fya and Fyb peptides and Fy^{a} and Fy^{b} monoclonal antibodies. SPOTs analysis identified Rh peptides that reacted specifically with their cognitive antibody.

### Example 6

### Specific Binding of Antibodies to Synthetic Peptide Mimotopes Bound to Microsphere Beads

Further confirmation that the peptide mimotopes can specifically bind antibodies raised to native blood group antigens was achieved following the immobilisation of peptide mimotopes onto polystyrene LiquiChip Ni-NTA microsphere beads (Qiagen).

Peptide mimotopes (e.g. Fyb16; RhD12) were synthesised with a C-terminal tag consisting of 6 Histidine amino acids. Stock solutions (4 μg/ml) of the 6×His tagged peptide mimotopes were prepared in PBS/0.1% BSA. The peptides were immobilised onto the beads using the Ni-NTA groups attached to the surface of the beads, as follows. A 50 μl volume of a 4 μg/ml peptide stock (Fyb16 or RhD12) was mixed with an equal volume of LiquiChip Ni-NTA beads (Bead 50 or Bead 52, respectively). Following incubation with mixing at 4° C. overnight, the Bead/peptide mixture was diluted with 900 μl of PBS/0.1% BSA. The Bead/peptide mixture was vortexed for 2 minutes and then a 10 μl volume was aliquoted into the well of a 96-well, round-bottomed. ELISA plate (Nunc). A 10 μl volume of the test monoclonal antibody (LM447: anti-Fy^{b} or T27: anti-RhD) was added to the well of the ELISA plate and the reaction volume was made up to 60 μl with PBS/1% BSA. The plate was incubated at room temperature for 90 minutes, in the dark and then a 10 μl volume (200 ng) of phycoerythrin conjugated sheep anti-mouse IgG (added to wells containing the LM447: anti-Fy^{b} monoclonal antibody) or phycoerythrin conjugated goat anti-human IgM (added to wells containing the T27: anti-RhD monoclonal antibody) was added into the well. The plate was incubated at room temperature for a further 90 minutes, in the dark. The plate was briefly vortexed; then loaded into a Luminex 100 Analyser (Luminex). Confirmation of bound monoclonal antibody was determined by the detection of a phycoerythrin fluorochrome signal. The intensity of the signal equates to the quantity of monoclonal antibody bound to the immobilised peptide mimotope.

The results are set out in FIGS. 11 and 12 where specific binding of anti-Fyb monoclonal antibody (LM447) to Peptide Mimotope Fyb16 and specific binding of the anti-RhD monoclonal antibody (T27) to Peptide Mimotope RhD12 is shown.

### Example 7

### Specific Binding of Antibodies to Synthetic Peptide Mimotopes Bound to Superparamagnetic Beads

The ability of peptide mimotopes to specifically bind antibodies was further tested using superparamagnetic polystyrene beads (TALON Dynabeads; Invitrogen) in a modified gel agglutination assay.

A 50 μl volume of the magnetic beads was added to 700 μl of TBS (50 mM Tris-HCl pH7.5; 150 mM NaCl). Following mixing for 5 minutes at room temperature, the magnetic beads were isolated using a Magnetic Particle Concentrator (Invitrogen). The supernatant was discarded and the beads were washed for 5 minutes in 700 μl of TBS. The beads were again separated from the buffer using the MPC magnet, and then resuspended in 700 μl of TBS. Peptide mimotopes (e.g. Fyb16; RhD12) were synthesised with a C-terminal tag consisting of 6 Histidine amino acids. Stock solutions (100 μg/ml) of the 6×His tagged peptide mimotopes were prepared in PBS.

A 50 μl volume of diluted TALON beads was placed in the reaction chamber of an NaCl gel card (ID Microtyping System; Diamed), together with a 50 μl volume of diluted His-tagged peptide mimotope (e.g. RhD12) and 100 μl of test human monoclonal antibody (e.g. T27: anti-RhD). The gel card was incubated at 37° C. for 1 hour in an Incubator-ID (DiaMed). Following incubation, the card was centrifuged for 10 minutes in an ID Centrifuge 24S (DiaMed). Antibody-positive reactions are visualised by a layer of beads upon the surface of the gel matrix. In negative reactions, non-agglutinated beads pass through the gel matrix and form a pellet.

To test the binding of a murine monoclonal antibody (e.g. LM447: anti-Fy^{b} monoclonal antibody), a 1 μl volume of sheep anti-mouse IgG is first added to the reaction chamber of an NaCl gel card and allowed to equilibrate with the gel matrix for 10 minutes at room temperature, prior to the addition of a 50 μl volume of diluted TALON beads, a 50 μl volume of diluted His-tagged peptide mimotope (e.g. Fyb16) and 100 μl of the test murine monoclonal antibody (e.g. LM447: anti-Fy^{b}). The gel card was incubated at 37° C. for 1 hour in an ID Incubator (DiaMed). Following incubation, the card was centrifuged for 10 minutes in an ID centrifuge (DiaMed). Again the reaction was read visually.

These examples demonstrate that the synthetic peptide mimotopes are capable of specifically binding antibodies raised to native blood group antigens even when bound to a solid support. In these examples the solid support used is polystyrene Ni-NTA microsphere beads or supermagnetic polystyrene beads but it is envisaged that the synthetic peptide mimotopes will be capable of specifically binding antibodies raised to native blood group antigens when immobilised on any suitable support.

The results are identified in FIGS. 13 and 14 whereby specific binding of anti-RhD monoclonal antibody (T27) to Peptide Mimotope RhD12 and specific binding of the anti-Fy^{b} monocolonal antibody (LM447) to Peptide Mimotope Fyb16 is shown.

1. (canceled)

2. A method for detecting an antibody to a blood group antigen in a sample, the method comprising:
a) reacting a mimotope of said blood group antigen with the sample to be tested, and
b) detecting any reaction between the sample and the mimotope, wherein a reaction between the sample and the mimotope is indicative of the presence of an antibody to the blood group antigen.

3. The method of claim 2 wherein before step a) the mimotope is immobilised on a solid support.

4. The method of claim 3 wherein the solid support is selected from the group consisting of a membrane, glass slide and bead.

5. The method of claim 2 wherein the antibody is an alloantibody.

6-8. (canceled)

9. The method of claim 2 wherein the blood group antigen is selected from the group consisting of Rhesus, Kell, Duffy, Kidd, ABO, MNS, P, Lutheran, Lewis, Diego, Yt, Xg, Scianna, Dombrock, Colton, Landsteiner-Wiener, Chido-Rodgers, Hh, Kx, Gerbich, Cromer, Knops, Indian, Ok, Raph, JMH, I, Globoside and GIL antigen mimotopes.

10. A device for detecting the presence of an antibody to a blood group antigen in a sample, the device comprising an array of mimotopes of a blood group antigen.

11. The device of claim 10 wherein said mimotopes each comprise a sequence selected from the group consisting of at least one of SEQ ID Nos 1 to 311 or a peptide fragment, an immunoreactive analogue or derivative or a cross-reactive sequence thereof.

12. The method of claim 2 wherein the mimotope comprises a sequence selected from the group consisting of at least one of SEQ ID Nos 1 to 311 or a peptide fragment, an immunoreactive analogue or derivative or a cross-reactive sequence thereof.

13. The device of claim 10 wherein the mimotope is immobilised on a solid support.

14. A method of diagnosing diseases or a reaction to blood products involving the generation of alloantibodies or autoantibodies, the method comprising using a mimotope of a blood group antigen to identify antibodies associated with the disease.

15. The method of claim 14 wherein the disease is HTR, haemolytic disease of the newborn or autoimmune haemolytic anaemia.

16. The method of claim 14 wherein the blood group antigen is selected from the group consisting of Rhesus, Kell, Duffy, Kidd, ABO, MNS, P, Lutheran, Lewis, Diego, Yt, Xg, Scianna, Dombrock, Colton, Landsteiner-Wiener, Chido-Rodgers, Hh, Kx, Gerbich, Cromer, Knops, Indian, Ok, Raph, JMH, I, Globoside and GIL antigen mimotopes.

17. The method of claim 14 wherein the mimotope comprises a sequence selected from the group consisting of at least one of SEQ ID Nos 1 to 311 or a peptide fragment, an immunoreactive analogue or derivative or a cross-reactive sequence thereof.

18. The method of claim 14 comprising the steps of:
a) reacting a mimotope of said blood group antigen with the sample to be tested, and
b) detecting any reaction between the sample and the mimotope, wherein a reaction between the sample and the mimotope is indicative of the presence of an antibody to the blood group antigen.

19. The method of claim 18 wherein before step
a) the mimotope is immobilised on a solid support.

20. The method of claim 19 wherein the solid support is selected from the group consisting of a membrane, glass slide and bead.

21. The method of claim 18 wherein the antibody is an alloantibody.
